(19) United States
(12) Patent Application Publication
(10) Pub. No.: US 2021/0122478 A1
(43) Pub. Date: Apr. 29, 2021

(54) AIRCRAFT SYSTEMS AND RELATED METHODS

(71) Applicant: The Boeing Company, Chicago, IL (US)

(72) Inventors: Steve G. Mackin, Bellevue, WA (US); Marcus K. Richardson, Everett, WA (US); Jacob Bevan McWhirter, Lake Stevens, WA (US)

(21) Appl. No.: 16/665,893

(22) Filed: Oct. 28, 2019

(51) Int. Cl. B64D 13/08; F02C 7/32

(52) U.S. Cl. CPC B64D 13/08; B64D 2013/0688; F02C 7/32

(57) ABSTRACT

Aircraft cooling and heating systems and related methods are disclosed. An example apparatus includes an air compressor operatively coupled to a turbine engine. The air compressor is configured to generate compressed air at a first temperature. A vapor cycle system configured to reduce the first temperature of the compressed air provided by the air compressor to a second temperature that is less than the first temperature.

### FIELD

The present disclosure relates generally to aircraft and, more particularly, to aircraft systems and related methods.

### BACKGROUND

Commercial aircraft typically employ an environmental control system to pressurize a passenger cabin. Existing environmental control systems employ cooling systems including large air-to-air heat exchangers, utilizing ram air as a cooling medium, to cool a cabin supply air prior to supplying the air to the passenger cabin. However, aircraft cooling systems employing ram air as a working fluid can increase drag and, thus, reduce aircraft efficiency.

### SUMMARY

An example apparatus includes an air compressor operatively coupled to a turbine engine, the air compressor configured to generate compressed air at a first temperature. A vapor cycle system configured to reduce the first temperature of the compressed air provided by the air compressor to a second temperature that is less than the first temperature.

Another example system includes a supply air system to receive fan air and generate supply air for a cabin of the aircraft. A vapor-cycle system is to operate in at least one of a cooling mode or a heating mode. The vapor-cycle system is to reduce a temperature the supply air when operating in the cooling mode. The vapor cycle system is to increase a temperature of the supply air when operating in the heating mode.

A system includes a supply air system including a supply air compressor configured to receive fan air and generate a supply air for a cabin of the aircraft. A primary cooling system to cool the supply air prior to the supply air flowing to the cabin during operation of an aircraft engine, the primary cooling system includes a first closed loop, vapor-cycle system. An auxiliary cooling system to recirculate and cool the cabin air when the aircraft engine is not operating. The auxiliary cooling system includes a second closed loop, vapor-cycle system that is independent from the first closed loop, vapor-cycle system

The features, functions and advantages that have been discussed can be achieved independently in various embodiments or may be combined in yet other embodiments further details of which can be seen with reference to the following description and drawings.

### BRIEF DESCRIPTION OF THE DRAWINGS

FIG. 1 is an illustration of an example aircraft that may embody the examples described herein.

FIG. 2 is a schematic illustration an example aircraft engine having an example system disclosed herein.

FIG. 3 is a schematic illustration of the example system of FIG. 2 shown in an example cooling state.

FIG. 4 is a schematic illustration of the example system of FIG. 2 shown in an example heating state.

FIG. 5 is a schematic illustration of the example system of FIG. 2 shown in an example anti-icing state.

FIG. 6A is a perspective, cutaway view of the example aircraft engine of FIG. 2.

FIG. 6B is a side, cutaway view of the example aircraft engine of FIG. 2.

FIG. 6C is a top, cutaway view of the example aircraft engine of FIG. 2.

FIG. 7 is a schematic illustration an example auxiliary cooling system disclosed herein.

FIG. 8 is a flowchart representative of an example method that may be performed by the example system of FIGS. 2-5.

FIG. 9 is a schematic illustration of an example aircraft engine having another example system disclosed herein.

FIGS. 10A and 10B are schematic illustrations of another example aircraft engine having another example system disclosed herein.

FIG. 11 is a block diagram of an example processing platform structured to execute the instructions of FIG. 8 to implement an example system controller of any of the example systems of FIGS. 2-5, 9, 10A and/or 10B.

Wherever possible, the same reference numbers will be used throughout the drawing(s) and accompanying written description to refer to the same or like parts. As used in this patent, stating that any part (e.g., a layer, film, area, or plate) is in any way positioned on (e.g., positioned on, located on, disposed on, or formed on, etc.) another part, means that the referenced part is either in contact with the other part, or that the referenced part is above the other part with one or more intermediate part(s) located therebetween. Stating that any part is in contact with another part means that there is no intermediate part between the two parts.

### DESCRIPTION

Existing aircraft cooling systems include a shaft-driven air compressor mechanically coupled to, for example, a primary gas turbine engine. In operation, heated compressed air is channeled from the gas turbine engine, through a pylon, and into a wing of the aircraft. The heated air is then channeled from the wing into a cabin of the aircraft where large air-to-air heat exchangers, utilizing ram air as a cooling medium, are used to reduce an operational temperature of the compressed air to enable the compressed air to be distributed into the cabin.

However, ram air as a cooling medium is not an efficient working fluid (e.g., compared to a refrigerant). Additionally, large air-to-air heat exchangers employing ram air as a cooling medium typically involve formation of air scoops on aerodynamic surfaces (e.g., a fuselage) of an aircraft that can produce drag during flight. As a result, aircraft cooling systems employing ram air as a cooling medium can affect the efficiency of an aircraft engine. Further, work output by the engine to compress the heated air (e.g., the bleed air) is lost when the cooling system reduces the temperature of the heated air for use in the cabin. Thus, aircraft cooling systems employing bleed air and/or utilizing ram air as a working fluid may be less efficient than aircraft cooling systems that do not extract bleed air from the aircraft engine and/or employ ram air. Additionally, the extracted bleed air from the engine can be high pressure and/or high temperature air that may need to be routed through a wing of the aircraft to the air-to-air heat exchangers located remotely from the aircraft engine (e.g., within the fuselage belly), which can impact components (e.g., equipment, structural components, etc.) stored in the wing, fuel, and/or may add additional insulation constraints and thereby increases manufacturing costs and/or aircraft weight. In some examples, aircraft employ auxiliary power units (APU) to provide electricity (e.g., power to start the aircraft engines). Additionally, some APUs provide cooled and/or compressed air to increase passenger comfort when boarding the aircraft and before starting the aircraft engines. However, APUs can be relatively large in size, which increase aircraft weight and reduce aircraft efficiency.

Example cooling air systems and related methods disclosed herein provide compressed or pressurized air to the various systems of an aircraft such as, for example, an environmental control system (ECS), a thermal anti-icing system (e.g., a wing and/or engine anti-icing system), a pneumatic supply system (to supply pneumatic devices), and/or any other system of the aircraft that requires use of compressed air.

To provide conditioned air to a passenger cabin of an aircraft, example aircraft systems and related methods disclosed herein employ a supply air system and a vapor-cycle system (e.g., a primary or first vapor-cycle system). For example, the supply air system disclosed herein pressurizes the fan air to meet (e.g., but not exceed) the demand(s) of the systems of the aircraft. In some examples, aircraft systems disclosed herein utilize jet engine shaft horsepower to drive a cabin air supply compressor (e.g., a shaft-driven compressor) that pressurizes fan air for a passenger cabin.

In some examples, a compact vapor-cycle system disclosed herein is configured to cool the compressed fan air provided by the supply air system. Vapor-cycle systems employing refrigerants (e.g., a refrigerant, carbon dioxide (CO₂) as working fluids are more efficient than systems employing ram air as a cooling fluid. Furthermore, unlike conventional cooling systems, example cooling systems disclosed herein do not employ bleed air for cabin cooling. Therefore, the example aircraft systems disclosed herein do not waste energy of the engine, thereby improving engine efficiency. Additionally, example systems disclosed herein eliminate thermal issues associated with employing high temperature bleed air. For example, cooling systems disclosed herein route cooled air through wings of the aircraft and to the passenger cabin. In other words, heated air is not routed through the wings to large air-to-air heat exchangers as in conventional cooling systems. Thus, example cooling systems disclosed herein enable reduction of insulation in the wings, thereby reducing costs and weight. Further, example aircraft systems and related methods disclosed herein provide a more efficient cooling system compared to aircraft cooling systems that employ ram air by improving aerodynamic characteristics of an aircraft. For example, some example aircraft cooling systems disclosed herein do not employ a ram air circuit. Thus, ram air scoops typically required with cooling systems that employ ram air are not needed. Elimination of the ram air scoops from aerodynamic surfaces of the aircraft reduces drag, thereby improving an efficiency of the aircraft (e.g., increased fuel efficiency). Additionally, example aircraft systems disclosed herein eliminate the need for large air-to-air heat exchanges for cooling and/or conditioning cabin air, thereby reducing aircraft weight.

To meet cooling requirements during passenger boarding and prior to starting the aircraft engines, example aircraft cooling systems and related methods disclosed herein include auxiliary vapor-cycle refrigeration systems (e.g., a second refrigeration system). The auxiliary vapor-cycle refrigeration systems disclosed herein are relatively small in size and require only a supply of electrical power from an APU. As a result, aircraft employing the cooling systems disclosed herein can employ smaller sized auxiliary power units, thereby reducing aircraft weight. In other words, cooling systems disclosed herein can be used in place of the relatively large air conditioning pack units stored in pack bay of an aircraft. Additionally, cooling systems disclosed herein enable use of smaller APUs.

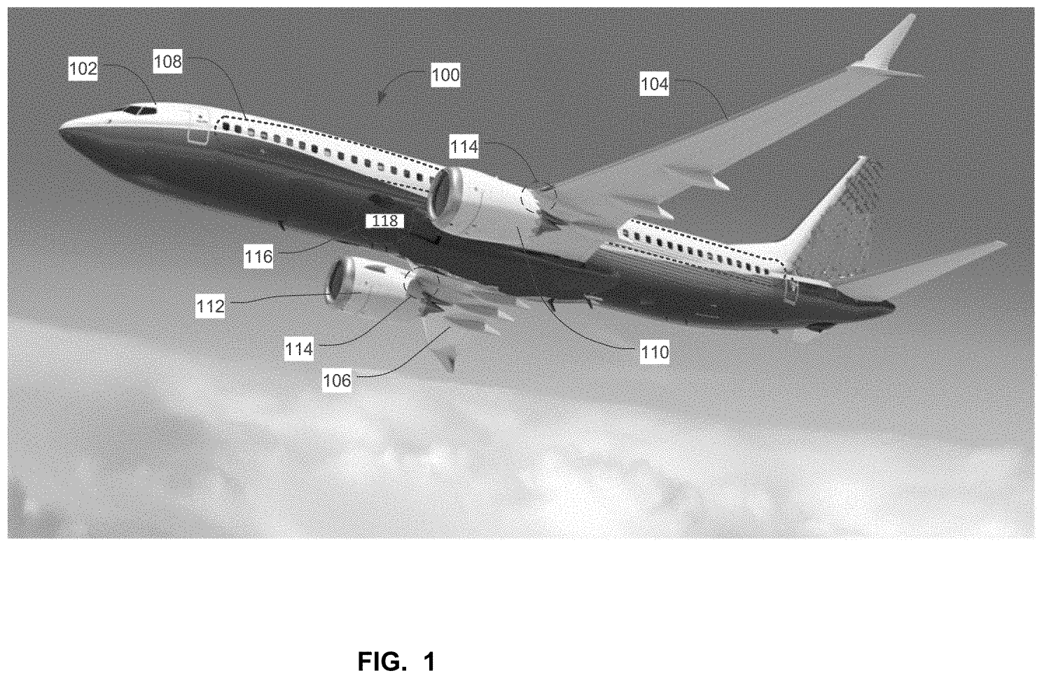

FIG. 1 illustrates an example aircraft 100 that embody aspects of the teachings of this disclosure. The aircraft 100 includes a fuselage 102, a first wing 104 coupled to the fuselage 102, and a second wing 106 coupled to the fuselage 102. The fuselage 102 defines a cabin 108 (shown in dashed lines) where the passengers and/or cargo are carried. In the illustrated example, the aircraft 100 includes an aircraft engine 110 carried by the wing 104 and an aircraft engine 112 carried by the second wing 106. In other examples, the aircraft 100 may include only one engine or may include more than two engines. The engine(s) can be carried on the wings 104, 106 and/or another structure on the aircraft 100 (e.g., on the tail section of the fuselage 102).

The aircraft 100 employs a primary aircraft system 114 and an auxiliary aircraft system 116. In some examples, the aircraft 100 can be implemented with the primary aircraft system 114 and without the auxiliary aircraft system 116. Alternatively, in some examples, the aircraft 100 can be implemented with the auxiliary aircraft system 116 and without the primary aircraft system 114. In other words, the primary aircraft system 114 and the auxiliary aircraft system 116 are independent systems (e.g., separate systems). Although the aircraft 100 is a commercial aircraft, the primary aircraft system 114 and/or the auxiliary aircraft system 116 can be implemented with other types of aircraft (e.g., military aircraft, etc.). The primary aircraft system 114 is to cool a supply air prior to the supply air flowing to a cabin during operation of an aircraft engine. In some examples, the primary aircraft system 114 is to heat a supply air prior to the supply air flowing to a cabin during operation of an aircraft engine. The primary aircraft system 114 includes a first closed loop, vapor-cycle system. The auxiliary aircraft system 116 is to recirculate and cool and/or heat the cabin air when the aircraft engine is not operating. The auxiliary aircraft system 116 includes a second closed loop, vapor-cycle system that is independent and/or isolated from the first closed loop, vapor-cycle system of the primary aircraft system 114.

In the illustrated example, at least some components of the primary aircraft system 114 are located in the aircraft engines 110, 112 (e.g., turbofan engines) of the aircraft 100. The auxiliary aircraft system 116 is located in the fuselage 102 of the aircraft 100. Specifically, the auxiliary aircraft system 116 is located in a pack bay area of the fuselage 102. The auxiliary aircraft system 116 is powered by an auxiliary power unit (APU). To exhaust heated air from the auxiliary aircraft system 116, the aircraft 100 (e.g., the fuselage 102) includes one or more vents 118 (e.g., aerodynamic vents). An example of the one or more vents is disclosed in U.S. Pat. No. 10,330,334, which is incorporated herein by reference in its entirety.

In operation, the primary aircraft system 114 and the auxiliary aircraft system 116 provide cool air to the cabin 108. Specifically, the primary aircraft system 114 provides cool air to the cabin 108 when the aircraft engines 110, 112 are active (e.g. running). For example, the primary aircraft system 114 provides cooled cabin air to the cabin 108 when the aircraft is taxiing, during take-off, during cruise and/or during landing. The auxiliary aircraft system 116 provides conditioned cabin air to the cabin 108 when the aircraft is on the ground and the aircraft engines 110, 112 are not running. For example, the auxiliary aircraft system 116 provides conditioned or cool cabin air when passengers are boarding the cabin 108 prior to starting the aircraft engines 110, 112.

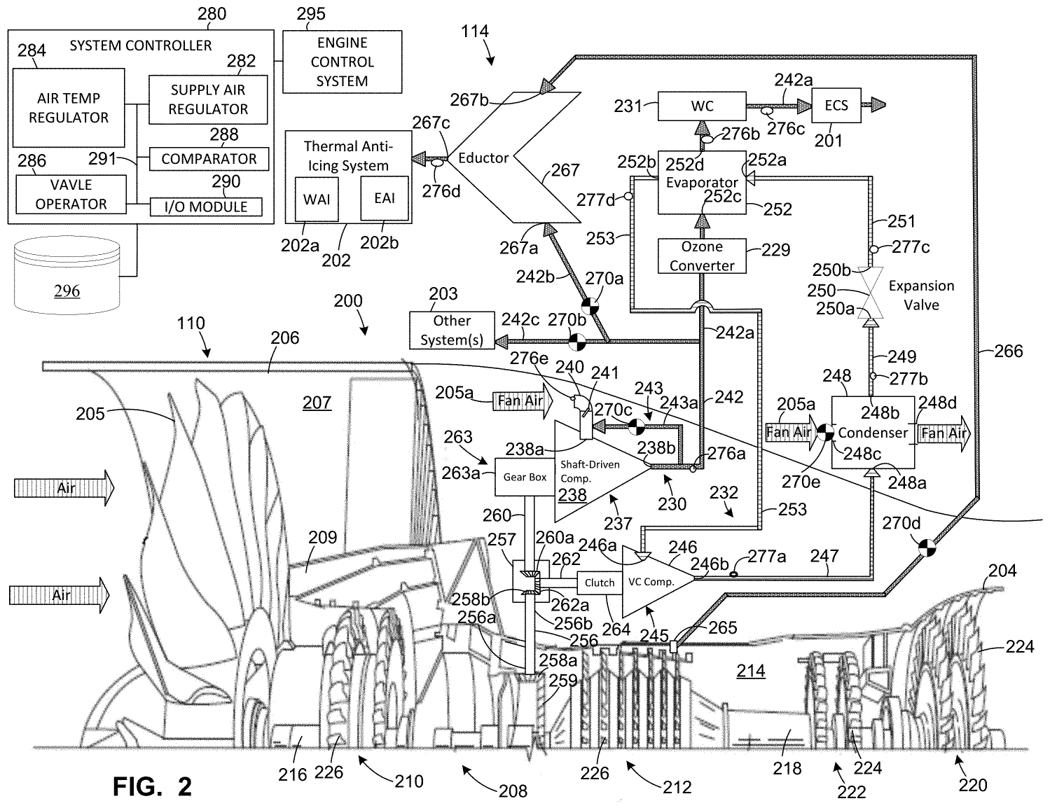

FIG. 2 is a schematic illustration of the primary aircraft system 114 constructed in accordance with the teachings of this disclosure. The primary aircraft system 114 is configured to provide supply air (e.g., pressurized or compressed air, cooled air, heated air, etc.) to different aircraft systems. For example, the primary aircraft system 114 provides supply air (e.g., pressurized, cooled and/or heated air) to various systems including, for example, an environmental control system (ECS) 201, a thermal anti-icing system (TAI) 202 that includes an engine anti-icing system (EAI) 202a and a wing anti-icing system (WAI) 202b and/or any other aircraft system(s) 203 of an aircraft that utilizes pressured, cooled and/or heated air. The ECS 201, for example, conditions cabin supply air to a cabin pressure and/or cabin temperature and supplies the conditioned air to the cabin 108 of the fuselage 102 (FIG. 1). In particular, air provided by the ECS 201 is used to pressurize the cabin 108 as well as provide cooled and/or heated air for regulating a temperature of the air in the cabin 108 to a comfortable setting. The EM 202a and the WAI 202b utilize the supply air to de-ice or prevent ice formation on exterior surfaces of the aircraft engines 110, 112 and the wings 104, 106 of FIG. 1, respectively. The supply air can be provided to the other aircraft system(s) 203 including, for example, pneumatic system(s), etc.

The primary aircraft system 114 of FIG. 2 is shown as being implemented in connection with the aircraft engine 110 (shown in a partial cutaway view) of the aircraft 100 (FIG. 1). A system similar to the primary aircraft system 114 can be implemented in connection with the aircraft engine 112 (FIG. 1). Thus, in some examples, each of the aircraft engines 110, 112 includes the primary aircraft system 114. In some examples, each of the aircraft engines 110, 112 employs a dedicated primary aircraft system 114. This configuration enables the primary aircraft system 114 of each of the aircraft engines 110, 112 to work together to meet the supply air demands of the aircraft systems (e.g., the ECS 201, TAI 202, etc.) and/or provide redundancy. In some examples, only one of the aircraft engines 110, 112 includes the primary aircraft system 114 disclosed herein.

Referring to FIG. 2, the aircraft engine 110 is a turbofan engine having a gas turbine engine 204 (sometimes referred to as an engine core) and a fan 205. The gas turbine engine 204 drives the fan 205 to produce thrust. The fan 205 rotates within a nacelle 206 of the aircraft engine 110. As the fan 205 rotates, the fan 205 produces airflow. A portion of the airflow flows through a fan bypass 207 (e.g., a duct, a passageway, a channel, a nozzle duct, etc.) that bypasses the gas turbine engine 204 and another portion of the airflow is also provided to the gas turbine engine 204 for combustion.

The gas turbine engine 204 operates by drawing air, via the fan 205, through a compressor intake section 209 of an engine compressor 208 in the gas turbine engine 204. The engine compressor 208 includes multiple compressor sections. For example, as shown, the engine compressor 208 is a dual-axial compressor that includes two compressors, a first or low-pressure compressor (LPC) 210 and a second or high-pressure compressor (HPC) 212. In the example shown, the LPC 210 provides relatively low pressure air and the HPC 212 provides relatively high pressure air. However, in other examples, the engine compressor 208 may include more or fewer compressor sections, each having, for example, a turbine and a shaft. The LPC 210 and HPC 212 are operatively coupled to respective engine shafts 216, 218. The engine shaft 216 is operatively coupled to a low-pressure turbine 220 and the engine shaft 218 is operatively coupled to a high-pressure turbine 222.

After exiting the HPC 212, the highly pressurized air is provided to a combustion chamber 214, where fuel is injected and mixed with the high pressure air and ignited. The high energy airflow exiting the combustion chamber 214 turns blades 224 of the turbines 220, 222, which are coupled to respective ones of the engine shafts 216, 218. Rotation of the engine shafts 216, 218 turns blades 226 of the LPC 210 and HPC 212. The heated air is exhausted via a nozzle where it mixes with cooler air, provided by the fan 205, that bypasses the gas turbine engine 204 (e.g., the engine core) via the fan bypass 207 to produce forward thrust that propels the aircraft 100 (FIG. 1) in a forward direction. While in this example the aircraft engine 110 is implemented as a turbofan engine, the primary aircraft system 114 can similarly be implemented in connection with other types of engines.

The primary aircraft system 114 of the illustrated example includes a supply air system 230 and a primary cooling system 232. To supply different systems of the aircraft 100 with pressurized supply air, the aircraft includes the supply air system 230. The supply air system 230 provides pressurized supply air to the ECS 201, the TAI 202, and/or the other aircraft system(s) 203 of an aircraft that uses pressurized air (e.g., pneumatic systems, etc.). For example, the supply air system 230 provides pressurized air to the ECS 201, which provides the pressurized air to the cabin 108 of the aircraft 100 of FIG. 1.

To generate pressurized supply air, the supply air system 230 of the illustrated example includes a supply air (SA) compressor system 237. The SA compressor system 237 includes a supply air (SA) compressor 238 (e.g., a low pressure compressor). The SA compressor 238 has a SA compressor inlet 238a and a SA compressor outlet 238b. The SA compressor 238 receives fan air 205a from the fan bypass 207 at the SA compressor inlet 238a and provides compressed air at the SA compressor outlet 238b. Thus, in this example, the SA compressor system 237 boosts fan air from the fan bypass 207. For example, the SA compressor system 237 or the SA compressor inlet 238a receives the fan air 205a (e.g., atmospheric air, non-compressed air) produced by the fan 205 and compresses the fan air 205a to provide a pressurized supply air to the various aircraft system(s) (e.g., the ECS 201, the TAI 202, etc.). For example, the SA compressor inlet 238a receives the fan air 205a (e.g., air at atmospheric pressure and/or temperature) and provides compressed air at the SA compressor outlet 238b having a pressure of between approximately 12 psi and 30 psi and a temperature of between approximately 50° F. and 500° F. for use by the ECS 201, the TAI 202 and/or the other aircraft system(s) 203. The supply air system 230 includes an ozone converter 229 to reduce ozone levels in the cabin 108 that can otherwise cause passenger discomfort and a water collector 231 to collect condensation and/or moisture in the supply air prior to providing the supply air to the ECS 201.

To receive the fan air 205a at the SA compressor inlet 238a, the supply air system 230 includes a fan air passageway 240 (e.g., a duct or conduit). The fan air passageway 240 fluidly couples the fan air 205a and the SA compressor inlet 238a. To account for varying inflow conditions (e.g., temperature fluctuations of the fan air 205a) and varying outflow demands, the fan air passageway 240 (e.g., and/or the SA compressor 238) includes variable geometry features such as a movable or adjustable guide vane 241 (e.g., an inlet guide vanes and/or diffuser guide vanes, a variable inlet guide vane) to enable the SA compressor 238 to handle a range of variability in the inlet conditions (e.g., fan air temperature) and the outlet demands (e.g., supply air pressure). In some examples, the fan air passageway 240 includes a valve in place of or in addition to the adjustable guide vane 241. The fan air passageway 240 includes the adjustable guide vane 241 to control an amount of airflow (e.g., a mass flow rate) to the SA compressor inlet 238a. More particularly, in some examples, the adjustable guide vane 241 can be adjusted to achieve a higher or a lower air flow (e.g., a mass flow rate) and/or pressure at the SA compressor outlet 238b. For example, the adjustable guide vane 241 moves between an open position (e.g., a fully open position) to allow fluid flow to the SA compressor inlet 238a and a closed position (e.g., a fully closed position) to prevent or restrict fluid flow to the SA compressor inlet 238a. In other examples, a vane-less diffuser or system having a ported shroud can be employed to account for varying inflow conditions and outflow demands.

A supply air passageway 242 (e.g., a duct, hose or conduit) fluidly couples the SA compressor outlet 238b to the different aircraft systems. For example, the supply air passageway 242 fluidly couples the supply air from the SA compressor outlet 238b to the ECS 201 via a first supply air passageway 242a, the TAI 202 via a second supply air passageway 242b, and the other aircraft system(s) 203 via a third supply air passageway 242c.

To increase a temperature and/or a pressure of the supply air exiting the SA compressor outlet 238b, the supply air system 230 includes a recirculation system 243 (e.g., a recirculation loop). The recirculation system 243 includes a recirculation passageway 243a fluidly coupling the SA compressor outlet 238b and the SA compressor inlet 238a. The recirculation system 243 channels or returns pressurized supply air from the SA compressor outlet 238b to the SA compressor inlet 238a. The SA compressor 238 compresses the recirculated pressurized supply air from the recirculation passageway 243a of the recirculation system 243, causing the pressurized supply air from the recirculation passageway 243a to increase in temperature and/or pressure at the SA compressor outlet 238b. For example, a first pass of the fan air 205a through the SA compressor 238 increases fan air temperature and/or fan air pressure from ambient temperature and/or pressure to a first temperature and/or a first pressure that is greater than the ambient temperature and/or the ambient pressure of the fan air 205a. A second pass of the pressurized supply air having the first temperature and/or the first pressure through the SA compressor 238 via the recirculation passageway 243a increases a temperature and/or a pressure of the pressurized supply air from the first temperature and/or the first pressure to a second temperature and/or a second pressure greater than the first temperature and/or the first pressure. For example, the recirculation system 243 can be employed when fan air temperature (e.g., ambient temperature) is relatively cold (e.g., less than 50° F.) and/or a pressure of the fan air 205a is below a desired threshold.

To cool or condition the supply air from the supply air system 230 for the ECS 201 (e.g., the cabin 108 of FIG. 1), the aircraft engine 110 employs the primary cooling system 232 (e.g., a cooling, closed-loop circuit). Specifically, the primary cooling system 232 is a vapor-cycle cooling system that uses a circulating working fluid (e.g., a refrigerant) as the medium to absorb and remove heat from the supply air. For example, the primary cooling system 232 employs carbon dioxide (CO₂) as a working fluid. However, in other examples, the primary cooling system 232 can employ a refrigerant such as, R134a and/or any other fluid or refrigerant as a working fluid.

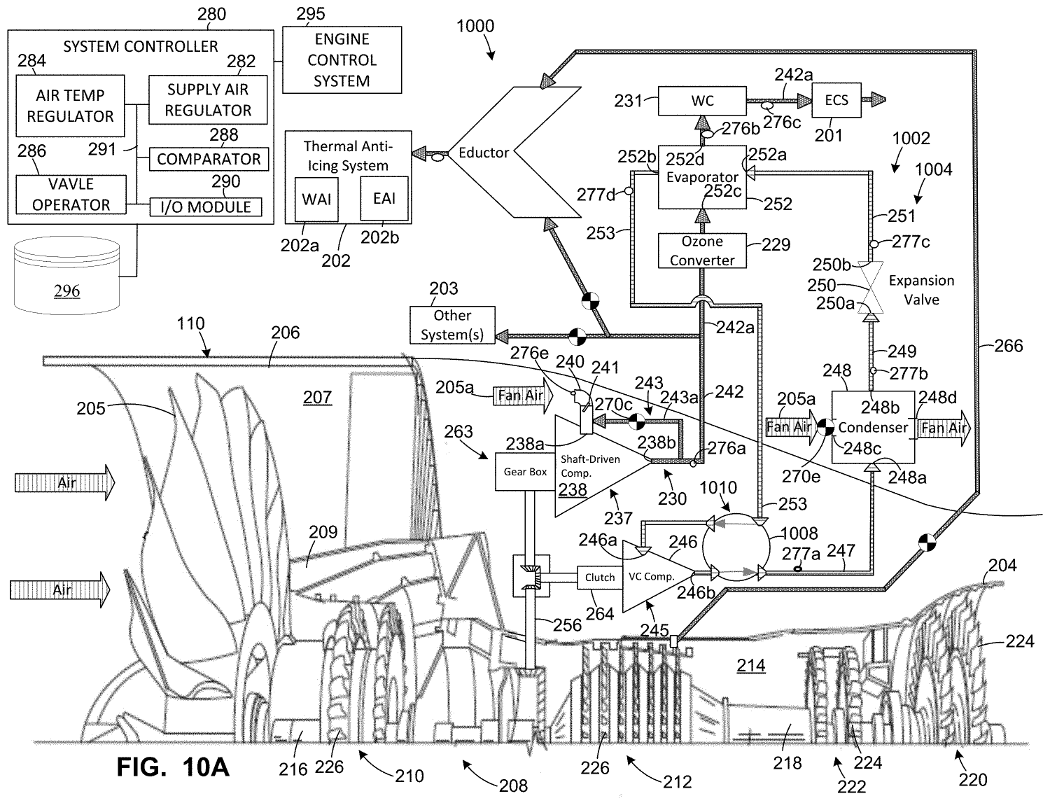

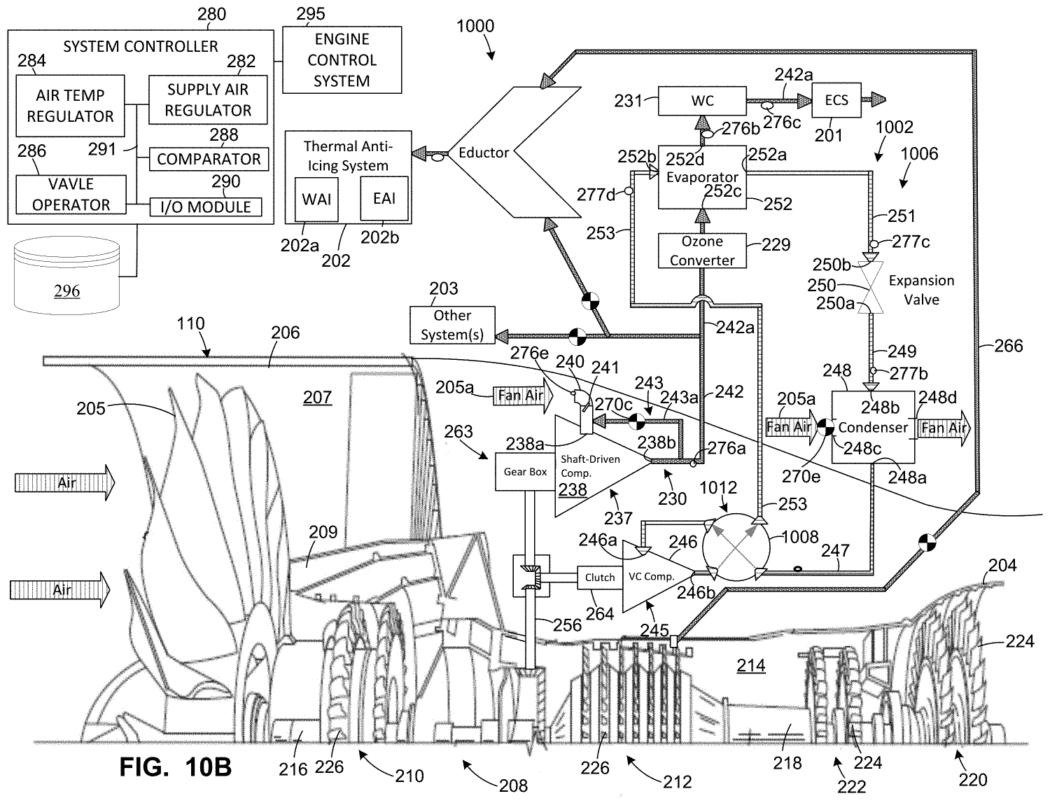

The primary cooling system 232 includes a vapor-cycle system 245 having a vapor-cycle (VC) compressor 246. The primary cooling system 232 includes a condenser 248, an expansion valve 250, and an evaporator 252. For example, the primary cooling system 232 includes a primary cooling passageway 247, a primary cooling passageway 249, a primary cooling passageway 251 and a primary cooling passageway 253 for transferring a working fluid between the VC compressor 246, the condenser 248, the expansion valve 250, and the evaporator 252. Unlike known cooling systems (e.g., ram air cooling systems), the vapor-cycle system 245 disclosed herein does not employ water or air as a working fluid. To the contrary, the vapor-cycle system 245 employs a refrigerant (e.g., hydrofluorocarbon (R-134a)) and/or carbon dioxide (CO₂) (R-744) as a working fluid for removing heat (e.g., and/or adding heat (FIG. 10B), which increases the efficiency of the primary aircraft system 114.

The VC compressor 246 is fluidly coupled to the condenser 248 via the primary cooling passageway 247, the condenser 248 is fluidly coupled to the expansion valve 250 via the primary cooling passageway 249, the expansion valve 250 is fluidly coupled to the evaporator 252 via the primary cooling passageway 251, and the evaporator 252 is fluidly coupled to the VC compressor 246 via the primary cooling passageway 253. In particular, the VC compressor 246 includes an VC compressor inlet 246a and a VC compressor outlet 246b. The VC compressor outlet 246b is fluidly coupled to a condenser working fluid inlet 248a (i.e., a working fluid inlet) of the condenser 248 via the primary cooling passageway 247. A condenser working fluid outlet 248b is fluidly coupled to an expansion valve inlet 250a via the primary cooling passageway 249. An expansion valve outlet 250b is fluidly coupled to an evaporator working fluid inlet 252a (e.g., a working fluid inlet) via the primary cooling passageway 251. An evaporator working fluid outlet 252b (e.g., a working fluid outlet) is fluidly coupled to the VC compressor inlet 246a via the primary cooling passageway 253. To remove heat from the working fluid of the primary cooling system 232, the condenser 248 includes a condenser air inlet 248c and a condenser air outlet 248d. To allow the supply air to flow through the evaporator 252, the evaporator 252 includes an evaporator supply air inlet 252c and an evaporator supply air outlet 252d.

Specifically, the primary cooling system 232 is a closed loop, vapor-cycle cooling system. In other words, the working fluid of the primary cooling system 232 does not mix with (i.e., is fluidly separated from) the supply air provided by the supply air system 230. For example, the primary cooling passageways 247, 249, 251, 253 form a closed loop system with the VC compressor 246, the condenser 248, the expansion valve 250 and the evaporator 252. For example, the primary cooling passageways 247, 249, 251 and 253 (and the VC compressor 246, the condenser 248, the expansion valve 250, and the evaporator 252) fluidly isolate the working fluid from the fan air in the fan air passageway 240 and the supply air in the supply air passageway 242, 242a-c. For example, the primary cooling passageways 247, 249, 251, 253 (and the VC compressor 246, the condenser 248, the expansion valve 250, and the evaporator 252) fluidly isolate (e.g., prevent mixing between) the working fluid of the primary cooling system 232 and the supply air flowing in the supply air passageways 242, 242a-c of the supply air system 230 and the evaporator 252, and fluidly isolate (e.g. prevent mixing between) the working fluid of the primary cooling system 232 and the fan air 205a flowing or passing through the condenser air inlet 248c and the condenser air outlet 248d. The supply air flows through evaporator 252 and over coils including the working fluid to transfer heat between the working fluid and the supply air, and fan air 205a flows through the condenser 248 and over coils including the working fluid to transfer heat between the working fluid and the fan air 205a.

In the illustrated example, the SA compressor system 237 (e.g., the SA compressor 238) and the vapor-cycle system 245 (e.g., the VC compressor 246) are shaft-driven compressor systems driven by the aircraft engine 110. To operate the SA compressor 238 and the VC compressor 246, a primary driveshaft 256 (e.g., a radial driveshaft) couples the aircraft engine 110 (e.g., a gas turbine engine) and the SA compressor 238 and the VC compressor 246, where the aircraft engine 110 drives the SA compressor 238 and the VC compressor 246 via the primary driveshaft 256. In the illustrated example, a first end 256a of the primary driveshaft 256 is operatively coupled to the aircraft engine 110 and a second end 256b of the primary driveshaft 256 is operatively coupled to a gearbox 257. Specifically, the first end 256a of the primary driveshaft 256 is coupled to a first gear 258a. The first gear 258a is engaged with a second gear 259 (e.g., a spool) of the aircraft engine 110 that is operatively coupled to the engine shaft 218 of the HPC 212. In the example shown, the first and second gears 258a, 259 are bevel gears and are oriented substantially perpendicular to each other. As the engine shaft 218 rotates about its longitudinal axis, the second gear 259, which is engaged with the first gear 258a, rotates the first gear 258a and, thus, the primary driveshaft 256 about its longitudinal axis.

To drive the SA compressor 238 and the VC compressor 246 via the primary driveshaft 256, the primary driveshaft 256 is operatively coupled a first driveshaft 260 (e.g., a radial driveshaft) and a second driveshaft 262 (e.g., a radial driveshaft) via the gearbox 257 (e.g., a bevel gear box). In particular, the primary driveshaft 256 rotates the first driveshaft 260 and the second driveshaft 262 via the gearbox 257. Specifically, the second end 256b of the primary driveshaft 256 includes a second gear 258b (e.g., a bevel gear) that enmeshes with a gear 262a of the second driveshaft 262, and the gear 262a of the second driveshaft 262 enmeshes with a gear 260a of the first driveshaft 260. The gear 262a of the second driveshaft 262 is positioned between the second gear 258b of the primary driveshaft 256 and the gear 260a of the first driveshaft 260. Thus, the primary driveshaft 256 drives or rotates the second driveshaft 262 via engagement with the gear 262a, which drives or rotates the first driveshaft 260 via engagement with the gear 260a of the first driveshaft 260. The gearbox 257 provides a one-to-one speed ratio such that the first driveshaft 260 operatively coupled to the SA compressor 238 and the second driveshaft 262 operatively coupled to the VC compressor 246 rotate at a substantially similar speed as the primary driveshaft 256 and, thus, the engine shaft 218 (e.g., of the HPC 212). In some examples, the gearbox 257 can provide a variable speed output (e.g., a different speed ratio) to the first driveshaft 260 and/or the second driveshaft 262. Although the first gear 258a is shown as operatively coupled to the engine shaft 218 in the illustrated example, in other examples, the first gear 258a can be operatively coupled to and driven by the engine shafts 216 (e.g., the shaft of LPC 210) or any other driveshaft of the aircraft engine 110. In the illustrated example, a gear ratio is employed between the engine shaft 218 and the SA compressor 238. The gears 259, 258a are sized to enable the SA compressor 238 to boost a pressure of the fan air received from the fan bypass 207 to a pressure demanded by the ECS 201, the TAI 202, and/or other aircraft system(s) 203. In some examples, the SA compressor 238 boosts a pressure of the fan air 205a from the fan bypass 207 by a factor of between approximately 1.5 and 3.5. The SA compressor 238 and/or the VC compressor 246 can be, for example, a centrifugal compressor, an axial compressor, a mixed-flow compressor, a low pressure compressor, and/or any other compressor.

To vary (e.g., increase or decrease) a speed of the SA compressor 238 relative to the aircraft engine 110 (e.g., a rotational speed provided by the primary driveshaft 256), the SA compressor system 237 includes a transmission 263 (e.g., a continuous variable transmission). The transmission 263 is installed between the aircraft engine 110 (e.g., the engine shaft 218) and the SA compressor 238. The transmission 263 enables a speed of the SA compressor 238 to vary (e.g., increase or decrease) relative to an operating speed of the aircraft engine 110 (e.g., the engine shaft 218). The transmission 263 includes a gearbox 263a that operatively couples to the SA compressor 238 and the first driveshaft 260. The first driveshaft 260 rotates to provide power to the gearbox 263a and, thus, to the SA compressor 238. In some examples, the gearbox 263a can be operatively coupled to one or more other systems used in the aircraft 100 such as, for example, an electrical generator and/or a hydraulic pump.

To engage and/or disengage the primary cooling system 232, the vapor-cycle system 245 includes a clutch 264. The clutch 264 moves between an engaged position to rotatably couple the second driveshaft 262 and the VC compressor 246 and a disengaged position to decouple the second driveshaft 262 and the VC compressor 246. In the deactivated position, the clutch 264 prevents rotation of the VC compressor 246 and, thus, movement of the working fluid through the primary cooling passageways 247, 249, 251 and 253 of the primary cooling system 232. In this manner, the clutch 264 can be employed to deactivate the primary cooling system 232 when supply air cooling is not desired. The VC compressor 246 operates at the same speed as the primary driveshaft 256 and/or the second driveshaft 262. However, in some examples, a transmission (e.g., a continuous variable speed transmission) can be provided to vary (e.g., increase or decrease) a speed of the VC compressor 246 relative to a speed of the aircraft engine 110 (e.g., the engine shaft 218 and/or the primary driveshaft 256). The SA compressor system 237 and the vapor-cycle system 245 are external relative to the gas turbine engine 204 of the aircraft engine 110. For example, the SA compressor 238, the VC compressor 246, the gearbox 257 and/or the gearbox 263a are disposed within the nacelle 206 (e.g., an upper bifurcation) of the aircraft engine 110.

Unlike known systems, the SA compressor system 237 extracts the fan air 205a (e.g., having a lower pressure and is relatively cooler) instead of, for example, bleed air from the LPC 210 and uses the power from the engine shaft 218 to boost the pressure of the air an appropriate amount for the aircraft systems (e.g., the ECS 201, the TAI 202, the other aircraft system(s) 203). As a result, the SA compressor system 237 does not utilize a precooler or intercooler to reduce a temperature of the air which wastes energy that was used to produce the relatively higher pressurized bleed air in the LPC 210.

To increase a temperature of the supply air when the supply air provided by the SA compressor system 237 is less than a desired upper threshold, the primary aircraft system 114 extracts bleed air (e.g., high temperature bleed air) from the aircraft engine 110 (e.g., the gas turbine engine 204). The TAI 202 receives bleed air from a bleed port 265 of the HPC 212. Specifically, the TAI 202 receives bleed air from the bleed port 265 via a bleed air passageway 266 (e.g., a conduit, a pipe, a duct, etc.). In the illustrated example, the TAI 202 employs an eductor 267 to mix the supply air from the SA compressor outlet 238b and the bleed air from the bleed port 265. For example, the eductor 267 has a first eductor inlet 267a in fluid communication with the second supply air passageway 242b to receive the supply air from the SA compressor 238 and a second eductor inlet 267b in fluid communication with the bleed air passageway 266 to receive the bleed air from the bleed port 265. The eductor 267 mixes the supply air and the bleed air to provide a thermal anti-icing fluid at an eductor outlet 267c of the eductor 267 having a temperature that is greater than the temperature of the supply air provided by the SA compressor 238. The eductor 267 provides the mixed fluid at the eductor outlet 267c to the TAI 202.

To control the supply air flow to the aircraft systems (e.g., the ECS 201, the TAI 202, the other aircraft system(s) 203) and/or to control parameters (e.g., flow rate, temperature, pressure, etc.) of the working fluid of the primary cooling system 232, the primary aircraft system 114 includes one or more valves 270a-e (e.g., control valves). For example, the primary aircraft system 114 includes a valve 270a interposed in the second supply air passageway 242b to control (e.g., modulate) supply air to the TAI 202, a control valve 270b interposed in the third supply air passageway 242c to control (e.g., modulate) supply air to the other aircraft system(s) 203, a valve 270c interposed in the recirculating passageway 243a to control (e.g., modulate) supply air through the recirculation passageway 243a, a valve 270d interposed in the bleed air passageway 266 to control (e.g., modulate) bleed air flow to the eductor 267, and a valve 270e at the condenser air inlet 248c to control fan air flow (e.g., a mass flow rate) through the condenser 248. Each of the valves 270a-e operates independently of the other valves and can operate between an open position (e.g., a fully open position or state) to allow fluid flow through the respective valves 270a-e and a closed position (e.g., a fully closed position or state) to prevent or restrict fluid flow through the respective valves 270a-e. Further, while five valves are illustrated in FIG. 2, one or more additional valves can be incorporated in other ones of the passageways 240, 242, 242a-e, 243a, 266, 247, 249, 251, 253, etc. The valves 270a-e can include a pressure-regulating valve (PRV), a pressure-regulating shut off valve (PRSOV), a shut off valve (SOV), a high pressure shut off valve (HPSOV), a back-flow prevention valve, a multi-flow directional valve, a three-way valve, a four-way valve, etc., and/or any other air control device. In some examples, the primary aircraft system 114 can include more or less than the number of valves 270a-e disclosed herein.

To measure parameters or characteristics of the primary aircraft system 114, the primary aircraft system 114 includes one or more sensors 276a-e, 277a-d (e.g., temperature sensors, pressure sensors, flow sensors, humidity sensors, etc.). For example, the primary aircraft system 114 includes one or more sensors 276a-d and one or more sensors 277a-d to measure temperature, pressure, water content, humidity, flow rate and/or any other parameter or characteristic of the primary aircraft system 114. For example, one or more sensor(s) 276a is/are coupled to the supply air passageway 242 to measure temperature, pressure and/or flowrate of the supply air exiting the SA compressor outlet 238d. One or more sensor(s) 276b is/are coupled to the first supply air passageway 242a to measure a temperature, pressure and flow rate of the supply air exiting the evaporator supply air outlet 252d. One or more sensor(s) 276c is/are coupled to the first supply air passageway 242a to measure temperature, pressure, flow rate, water content, and/or humidity of the supply air exiting the water collector 231 prior to the supply air flowing to the ECS 201. In some examples, the primary aircraft system 114 can include other sensor(s) to measure any other parameter(s) of the cabin supply air at various points in the primary aircraft system 114. One or more sensor(s) 276d is/are coupled to the eductor outlet 267c to measure temperature, pressure, flowrate, etc., of an anti-icing fluid for use by the TAI 202. One or more sensor(s) 276e is/are coupled to the fan air passageway 240 to measure one or more parameters (e.g., temperature, pressure, etc.) of the fan air 205a flowing to the SA compressor inlet 238a of the SA compressor 238. Additional sensors can be provided in various other locations to similarly measure one or more parameters of the supply air at various points in the supply air system 230.

One or more sensor(s) 277a is/are coupled to the primary cooling passageway 247 to measure temperature, pressure, flowrate, etc., of the working fluid exiting the VC compressor outlet 246b. One or more sensor(s) 277b is/are coupled to the primary cooling passageway 249 to measure temperature, pressure, flowrate, etc., of the working fluid exiting the condenser working fluid outlet 248b. One or more sensor(s) 277c is/are coupled to the primary cooling passageway 251 to measure temperature, pressure, flowrate, etc., of the working fluid exiting the expansion valve outlet 250b. One or more sensor(s) 277d is/are coupled to the primary cooling passageway 253 to measure temperature, pressure, flowrate, etc., of the working fluid exiting the evaporator working fluid outlet 252b. Additional sensors can be provided in various other locations to similarly measure one or more parameters of the working fluid at various points in the primary cooling system 232.

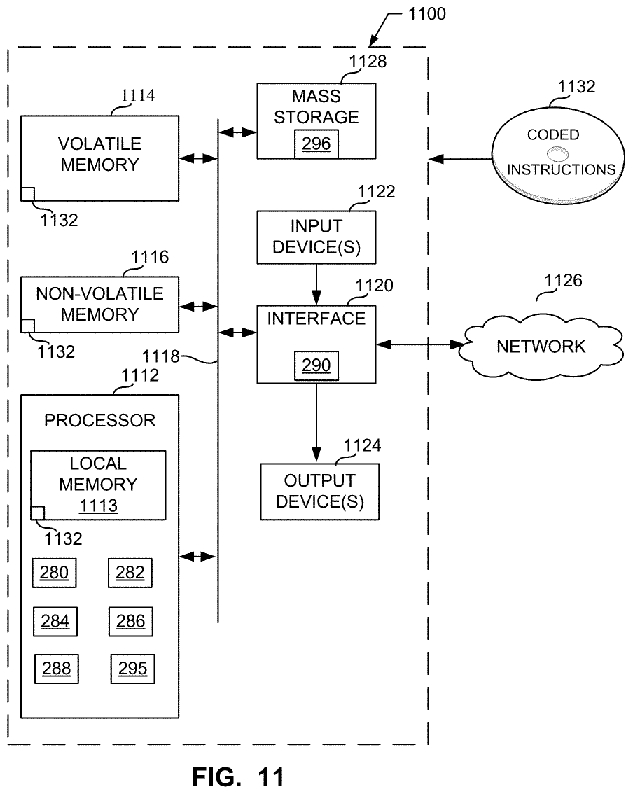

To control operation of the primary aircraft system 114, the primary aircraft system 114 includes a system controller 280. The system controller 280 can be implemented by a controller or processor, such as the processor 1112 of the processor platform 1100 disclosed in connection with FIG. 11. The system controller 280 is communicatively coupled to one or more the sensors 276a-e, 277a-d, the valves 270a-e, the adjustable guide vane 241, the gearbox 263a, the clutch 264, and/or any other device that controls and/or monitors various parameters (e.g., mass flow rate, pressure, temperature, etc.) of the primary aircraft system 114.

In the illustrated example, the system controller 280 includes a supply air regulator 282, an air temperature regulator 284, a valve operator 286, a comparator 288 and an input/output (I/O) module 290 communicatively coupled via a bus 291. In the illustrated example, the system controller 280 is communicatively coupled to an engine control system 295, which receives or determines operating parameters and/or flight conditions including, for example, altitude, air speed, throttle lever position, air pressure, air temperature, humidity, engine speed, air density, passenger count, and/or other parameter(s).

The I/O module 290 receives signals from one or more sensors 276a-e measuring one or more parameters of the supply air system 230. The I/O module 290 also receives signals from and one or more sensors 277a-d measuring one or more parameters of the working fluid of the primary cooling system 232. The comparator 288 compares the measured values of the parameter(s) to one or more thresholds or threshold ranges (e.g., stored in a database accessible by the system controller 280). Based on whether the parameter(s) satisfy the thresholds or threshold ranges, the valve operator 286 can operate one or more of the valves 270a-e to provide supply air having desired parameters (e.g., pressure and/or temperature) to the ECS 201, the TAI 202, and/or the other aircraft system(s) 203. For example, the valve operator 286 controls operating states of the valves 270a-e. For instance, any of the valves 270a-e can be operated between an open state (e.g., a fully open position) and a closed state (e.g., a fully closed position) and any state or position therebetween (e.g., a half open position) to control fluid flow through the respective fan air passageway 240, the supply air passageways 242a-c, the recirculation passageway 243a, the bleed air passageway 266, etc. The supply air regulator 282 controls the gearbox 263a (to control the speed of the SA compressor 238) and the adjustable guide vane 241, thereby controlling at least one of temperature, pressure, and/or flow rate of the air at the SA compressor outlet 238b. The air temperature regulator 284 controls the clutch 264 between a first or engaged position to operate the VC compressor 246 and a second or disengaged position to operatively decouple the VC compressor 246 from the second driveshaft 262 and/or the primary driveshaft 256. The valve operator 286 controls operating states of the expansion valve 250 and/or the valve 270e to control a parameter (e.g., a temperature and/or pressure) of the working fluid to achieve a desired supply air parameter (e.g., a temperature and/or pressure). For instance, the valve 270e and/or the expansion valve 250 can be operated between an open state (e.g., a fully open position) and a closed state (e.g., a fully closed position) and any state or position therebetween (e.g., a half open position) to control a parameter of the working fluid between the primary cooling passageway 247 and the primary cooling passageway 249 and/or a parameter of the working fluid between the primary cooling passageway 249 and the primary cooling passageway 251.

While an example manner of implementing the system controller 280 is illustrated in FIG. 2, one or more of the elements, processes and/or devices illustrated in FIG. 2 may be combined, divided, re-arranged, omitted, eliminated and/or implemented in any other way. Further, the supply air regulator 282, the cooling system controller 284, the valve operator 286, the comparator 288 and the input/output (I/O) module 290 and/or, more generally, the example system controller 280 of FIG. 2 may be implemented by hardware, software, firmware and/or any combination of hardware, software and/or firmware. Thus, for example, any of the supply air regulator 282, the cooling system controller 284, the valve operator 286, the comparator 288 and the input/output (I/O) module 290 and/or, more generally, the example system controller 280 of FIG. 2 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example, the supply air regulator 282, the cooling system controller 284, the valve operator 286, the comparator 288 and the input/output (I/O) module 290 is/are hereby expressly defined to include a non-transitory computer readable storage device or storage disk such as a memory, a digital versatile disk (DVD), a compact disk (CD), a Blu-ray disk, etc. including the software and/or firmware. Further still, the example system controller 280 of FIG. 2 may include one or more elements, processes and/or devices in addition to, or instead of, those illustrated in FIG. 2, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

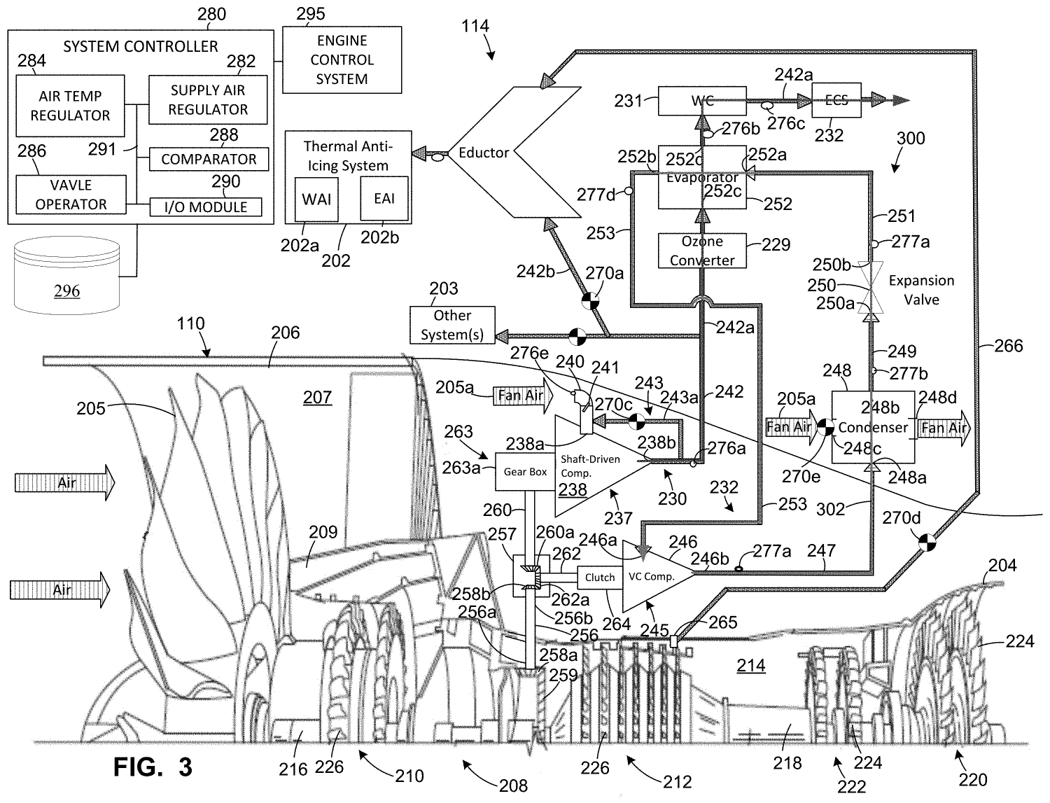

FIG. 3 is a schematic illustration of the primary aircraft system 114 of FIG. 2 shown in a cooling mode 300. In the cooling mode 300, the primary cooling system 232 is activated to reduce (e.g., cool) a temperature of the supply air flowing to the ECS 201 through the first supply air passageway 242a.

During operation, the primary aircraft system 114 provides conditioned air to the cabin 108. Specifically, the SA compressor system 237 provides supply air to the cabin 108 (via the ECS 201) based on a number of passengers in the cabin 108. To determine a mass flow rate of supply air to be supplied to the cabin 108, the supply air regulator 282 obtains, retrieves, and/or receives passenger count information from, for example, the database 296. The passenger count information can be manually stored in the database 296. For example, in some aircraft, the target flow rate can be 0.55 pound mass (lb.)/min/passenger. To provide the target mass flow rate, the supply air regulator 282 can operate or modulate the speed of the SA compressor 238 via the gearbox 263a and/or operate the adjustable guide vane 241 in the fan air passageway 240. For example, the supply air regulator 282 can receive one or more signals from the sensor 276e positioned in the fan air passageway 240 indicative or representative of a flow rate of the fan air 205a entering the fan air passageway 240 and one or more signals from the sensor 276a positioned in the supply air passageway 242 downstream from the SA compressor outlet 238b. Based on the measured flow rates at the fan air passageway 240 and the supply air passageway 242, the supply air regulator 282 operates the adjustable guide vane 241 and/or the gearbox 263a to achieve the target mass flow rate at the SA compressor outlet 238b and/or in the first supply air passageway 242a. For example, the supply air regulator 282 controls the gearbox 263a to control (e.g., increase or decrease) a speed of the SA compressor 238 and/or a position of the adjustable guide vane 241 (e.g., a variable inlet guide van), thereby controlling the mass flow rate of the supply air at the SA compressor outlet 238b. Further, the speed of the SA compressor 238 and/or the amount of airflow through the fan air passageway 240 and to the SA compressor inlet 238a can affect temperature and/or pressure of the supply air exiting the SA compressor outlet 238b. In some examples, the first supply air passageway 242a can include one or more pressure regulating instruments (e.g., pressure regulating valves, pressure regulators, etc.) to adjust (e.g., increase or decrease) a pressure of the supply air prior to flowing to the ECS 201 and/or the evaporator 252.

Additionally, the supply air regulator 282 and/or the valve operator 286 receives a temperature and/or a pressure from the sensor 276e positioned in the fan air passageway 240 and/or the sensor 276a positioned in the supply air passageway 242. The supply air regulator 282 and/or the valve operator 286 command the valve 270c to a closed position to restrict or prevent supply air recirculation (recirculation of supply air) to the SA compressor inlet 238a via the recirculation passageway 243a when the measured temperature and/or the measured pressure at the SA compressor outlet 238b exceeds a threshold temperature (e.g., 450° F.) and/or threshold pressure (e.g., 50 psi).

To reduce a temperature of the supply air to the ECS 201, the primary aircraft system 114 employs the primary cooling system 232. The air temperature regulator 284 receives a target temperature (e.g., 27° F.) from the supply air regulator 282. Additionally, the air temperature regulator 284 receives one or more signals from the one or more sensors 276a-c of the passageway 242 and/or the first supply air passageway 242a representative of a temperature of the supply air flowing through the first supply air passageway 242a. The comparator 288 compares the supply air temperature to a target temperature (e.g., retrieved from the database 296). The air temperature regulator 284 commands the clutch 264 to disengage the VC compressor 246 when the supply air temperature does not exceed the target temperature (e.g., turn off the primary cooling system 232) and commands the clutch 264 to engage the VC compressor 246 when the supply air temperature in the first supply air passageway 242a exceeds the target temperature. When the clutch 264 is engaged with the VC compressor 246, the primary driveshaft 256 drives or operates the VC compressor 246. The primary cooling system 232 activates to cool or reduce a temperature of the supply air in the first supply air passageway 242a to the target temperature. For example, in some aircraft, a target temperature of the cabin supply air is 27° Fahrenheit (F), the target pressure is 14 pounds-per-square-inch (PSI), and the flow rate is 0.55 pound mass (lb.)/min/passenger. In some examples, in some aircraft, a target temperature of the supply air to be provided to the ECS 201 is 10° Fahrenheit (F), the target pressure is 12 pounds-per-square-inch (PSI), and the flow rate is 0.55 pound mass (lb.)/min/passenger.

In particular, the primary cooling system 232 employs the vapor-cycle system 245 to remove heat from the supply air via heat transfer methods prior to supply air system 230 distributing the supply air to the ECS 201. The vapor-cycle system 245 of the primary cooling system 232 circulates working fluid (e.g., CO₂) in a closed loop passageway 302 in a unidirectional path through the primary cooling passageways 247, 249, 251 and 253.

During operation, the VC compressor 246, via engagement with the clutch 264, compresses the working fluid of the vapor-cycle system 245 to a saturated vapor, thermodynamic state having a relatively high temperature (e.g., 350° F.) and a relatively high pressure (e.g., 1000 psi). The circulating working fluid enters the VC compressor 246 , which compresses the saturated vapor to a higher pressure, resulting in a higher temperature. The VC compressor outlet 246b is fluidly coupled to a condenser working fluid inlet 248a of the condenser 248 via the primary cooling passageway 247. Thus, the hot, compressed vapor from the VC compressor outlet 246b is routed to the condenser working fluid inlet 248a via the primary cooling passageway 247. The hot, compressed vapor is in the thermodynamic state known as a superheated vapor and has a temperature and pressure that can be condensed with the fan air 205a (e.g., a cool air flowing) across or through the condenser 248. For example, the working fluid passes through one or more coils or fins of the condenser 248 and the fan air 205a is configured to pass over the coils or fins to remove heat from the working fluid. To control a temperature of the working fluid exiting the condenser working fluid outlet 248b, the air temperature regulator 284 receives one or more signals from the sensor 277b in the primary cooling passageway 249. To control an amount of air flow through the condenser 248, the condenser air inlet 248c employs the valve 270e. The air temperature regulator 284 controls operation of the valve 270e via the valve operator 286 based on a temperature (e.g., a target temperature) of the working fluid exiting the condenser working fluid outlet 248b provided by the sensor 277b. For example, the air temperature regulator 284 and/or the valve operator 286 operate the valve 270e to an open position to allow more fan air flow through the condenser 248 if a temperature of the working fluid measured by the sensor 277b exceeds a target temperature threshold and operate the valve 270e to a closed position to prevent or restrict air flow through the condenser 248 if a temperature of the working fluid measured by the sensor 277b does not exceed a target temperature threshold. In some examples, the condenser 248 employs a fan or blower to circulate the fan air 205a through the condenser 248 (e.g., across a coil or tubes carrying the cold working fluid through the condenser 248).

As the working fluid passes through the condenser 248 between the condenser working fluid inlet 248a and the condenser working fluid outlet 248b, and the fan air 205a flows through the condenser 248 between the condenser air inlet 248c and the condenser air outlet 248d, the circulating working fluid rejects heat from the primary aircraft system 114 and the rejected heat is carried away by the fan air 205a exiting the condenser air outlet 248d. The extracted heat from the working fluid causes the working fluid to reduce its temperature (e.g., from 350° F. to 90° F.). For example, as the working fluid exits the condenser 248, the condensed working fluid is a liquid, in the thermodynamic state known as a saturated liquid.

The condensed working fluid is routed to the expansion valve inlet 250a of the expansion valve 250 where it undergoes an abrupt reduction in pressure. That pressure reduction results in the adiabatic flash evaporation of a part of the working fluid that is in a liquid state. The effect of the adiabatic flash evaporation lowers a temperature of the liquid working fluid to a temperature (e.g., 32° F.). that is colder than a temperature (e.g., 90° F.)of the working fluid at the expansion valve inlet 250a. To adjust the temperature of the working fluid exiting the expansion valve outlet 250b, the expansion valve 250 modulates to control working fluid flow through the expansion valve 250. The air temperature regulator 284 and/or the valve operator 286 control operation of the expansion valve 250. For example, the expansion valve 250 is a digital expansion valve that is responsive to binary signals (e.g., a bit value of “1” to move to an open position and a bit valve of “0” to move to a closed position). However, in some examples, the expansion valve 250 can be a non-digital valve that operates based on a temperature of the working fluid exiting the evaporator working fluid outlet 252b (e.g., an expansion valve implemented with a sensing bulb). For example, the expansion valve 250 can include a sensing line (e.g., a sensing bulb) attached to the primary cooling passageway 253 adjacent the evaporator working fluid outlet 252b to sense a temperature of the working fluid at the evaporator working fluid outlet 252b.

To control operation of the expansion valve 250, the air temperature regulator 284 receives a temperature of the working fluid at the expansion valve outlet 250b via the sensor 277a of the primary cooling passageway 251, a temperature of the working fluid at the evaporator working fluid outlet 252b via the sensor 277d of the primary cooling passageway 253, and/or receives a measured temperature of the supply air in the first supply air passageway 242a via the sensor 276b and/or 276c. For example, the air temperature regulator 284 and/or the valve operator 286 operate the expansion valve 250 between an open position to allow or increase working fluid flow through the expansion valve 250 and a closed position to restrict or prevent (e.g., reduce) working fluid flow through the expansion valve 250. In some examples, the valve operator 286 causes the expansion valve 250 to move to an open position to increase a working fluid flow rate through the expansion valve 250 in response to the comparator 288 determining that the measured temperature of the working fluid exiting the evaporator 252 provided by the sensor 277d of the primary cooling passageway 253 exceeds (e.g., is greater than) a temperature threshold (e.g., retrieved from the database 296). Likewise, the valve operator 286 causes the expansion valve 250 to move to a closed position to prevent or reduce a working fluid flow rate through the expansion valve 250 in response to the comparator 288 determining that the measured temperature of the working fluid exiting the evaporator 252 provided by the sensor 277d of the primary cooling passageway 253 does not exceed (e.g., is less than) a temperature threshold.

The cold working fluid is then routed (e.g., through coil or tubes) in the evaporator 252 via the primary cooling passageway 251. The supply air passes through the evaporator 252 via the first supply air passageway 242a, where the supply air 242a has a temperature that is greater than the temperature of the working fluid passing through the evaporator 252. The warmer temperature supply air evaporates the cooler working fluid. Thus, the working fluid passing through the evaporator 252 absorbs and removes heat from the supply air (e.g., via convection) to reduce a temperature of the supply air. Specifically, the air temperature regulator 284 operates the valve 270e and/or the expansion valve 250 to achieve a working fluid having a temperature to remove an amount of heat from the supply air to achieve a temperature of the supply air at the evaporator supply air outlet 252d that is substantially equal (e.g., within 10 percent) of the target temperature. The working fluid increases in temperature as it absorbs heat from the supply air and converts to a saturated vapor at the evaporator working fluid outlet 252b. To complete the vapor cycle, the working fluid (e.g., saturated vapor) from the evaporator 252 is again a saturated vapor and is routed back into the VC compressor inlet 246a via the primary cooling passageway 253. The heat that is absorbed by the working fluid from the supply air passing through the evaporator 252 is subsequently rejected via the condenser 248 and transferred out of the closed loop passageway 302 by the fan air 205a passing through the condenser 248.

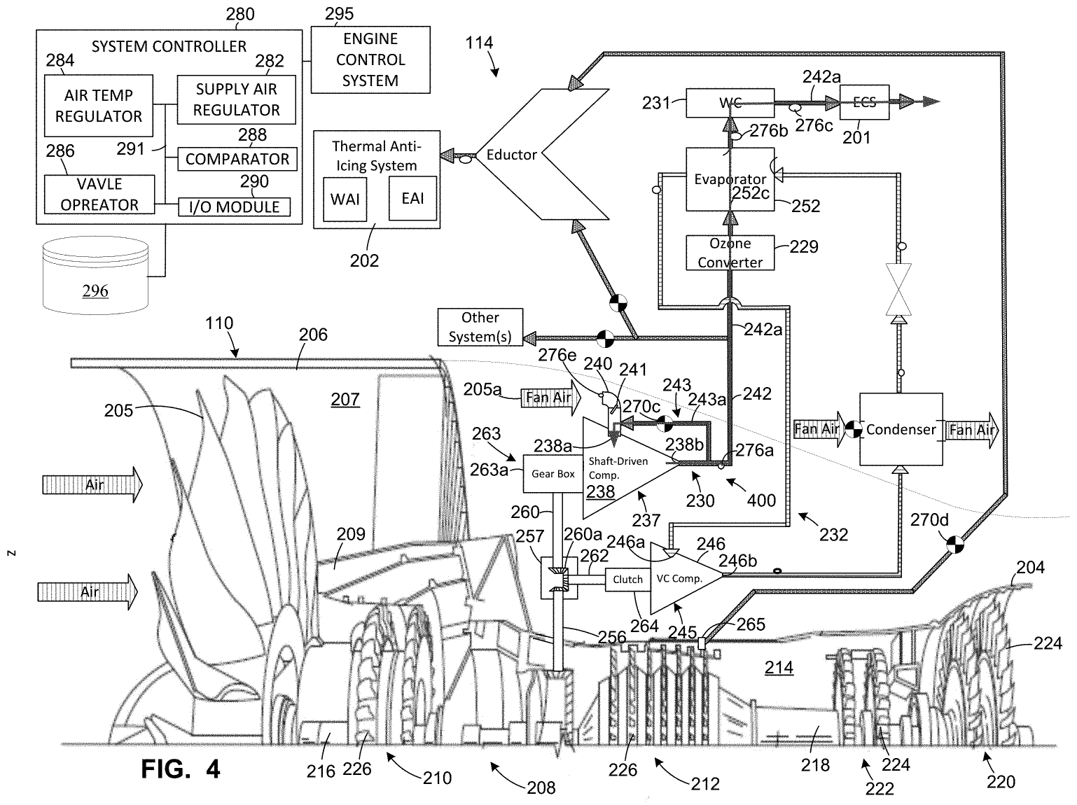

FIG. 4 is a schematic illustration of the primary aircraft system 114 shown in a heating cycle 400. The recirculation system 243 is employed to increase a temperature of the supply air to the first supply air passageway 242a. For example, the supply air regulator 282 and/or the air temperature regulator 284 receive a measured temperature of the fan air 205a via the sensor 276e of the fan air passageway 240 and/or the measured temperature of the supply air exiting the SA compressor outlet 238b via the sensor 276a of the supply air passageway 242. Additionally, the supply air regulator 282 receives a measured pressure of the supply air from the sensor 276e of the fan air passageway 240 and/or the sensor 276a of the supply air passageway 242.

The supply air regulator 282 and/or the valve operator 286 receives a temperature and/or a pressure from the sensor 276e positioned in the fan air passageway 240 and/or the sensor 276a positioned in the supply air passageway 242. The supply air regulator 282 and/or the valve operator 286 command the valve 270c to move to an open position to allow supply air recirculation (recirculation of supply air) to the SA compressor inlet 238a via the recirculation passageway 243a when the measured temperature and/or the measured pressure at the SA compressor outlet 238b does not exceed a threshold temperature (e.g.,450° F.) and/or threshold pressure (e.g., 50 psia). In this manner, the recirculated air can be recompressed, which can cause a temperature and/or a pressure of the supply air to increase. The recirculation system 243 can operate until the supply air at the SA compressor outlet 238b has a temperature and/or pressure that exceeds the temperature threshold and/or pressure threshold.

Additionally, the air temperature regulator 284 disengages the clutch 264 from the VC compressor 246 when the measured temperature at the SA compressor inlet 238a and/or the SA compressor outlet 238b does not exceed a temperature threshold. With the clutch in the disengaged position, the VC compressor 246 does not rotate via the primary driveshaft 256 and, thus, the primary cooling system 232 is deactivated.

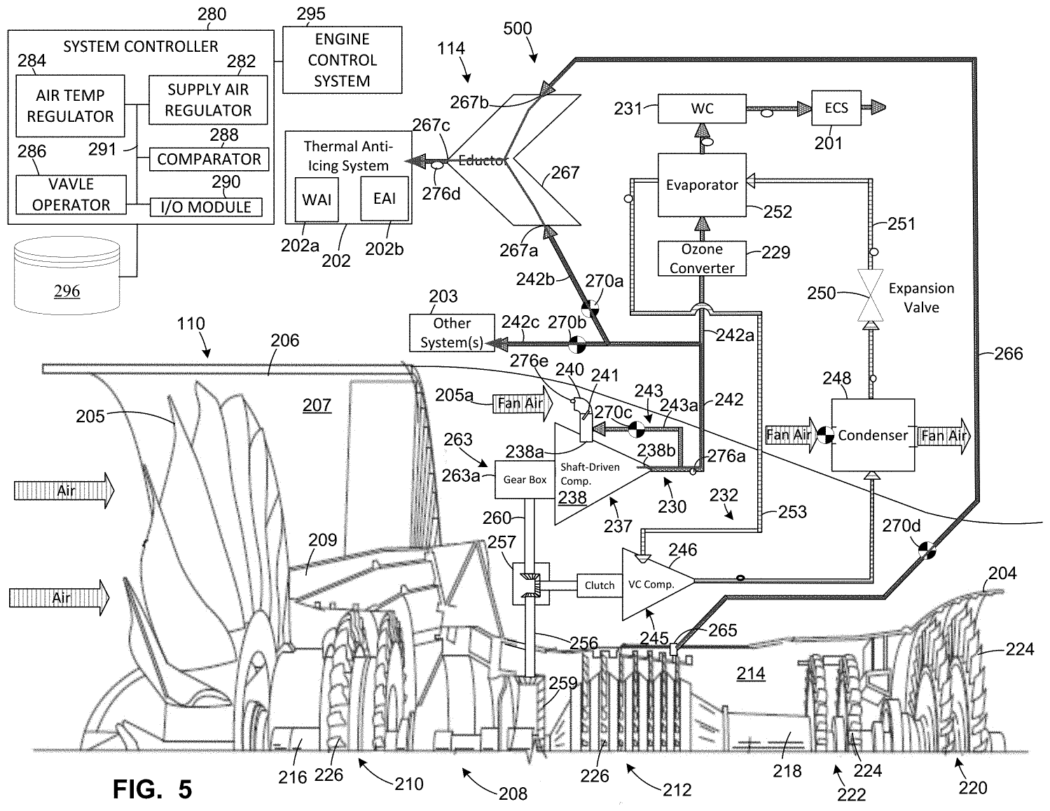

FIG. 5 is a schematic illustration of the primary aircraft system 114 shown in a thermal anti-icing condition 500. To provide supply air to the TAI 202, the supply air controller and/or valve operator 286 receives a signal from the engine control system 295 to activate the TAI 202. For example, the engine control system 295 and/or the supply air regulator 282 can determine that anti-icing is needed by measuring, via the one or more sensors, air temperature and/or humidity. The valve operator 286 causes the valve 270a to open to an open position to allow supply air from the SA compressor 238 to the eductor 267. The sensor 276d measures a temperature of the supply air exiting the eductor outlet 267c. If the comparator 288 determines that a temperature of the supply air at the eductor outlet 267c does not exceed an anti-icing temperature threshold, the valve operator 286 causes the valve 270d to move to an open position to allow hot bleed air from the bleed port 265 to flow to the second eductor inlet 267b. The eductor 267 causes the supply air from the first eductor inlet 267a to mix with the bleed air from the second eductor inlet 267b to increase a temperature of the anti-icing air exiting the eductor outlet 267c. For example, the valve operator 286 can modulate the valve 270e so that anti-icing air at the eductor outlet 267c has a temperature that exceeds the anti-icing temperature threshold. When anti-icing is not needed, the valve operator 286 causes the valve 270a and the valve 270d to move their respective closed positions to prevent supply air flow to the first eductor inlet 267a and bleed air flow to the second eductor inlet 267b.

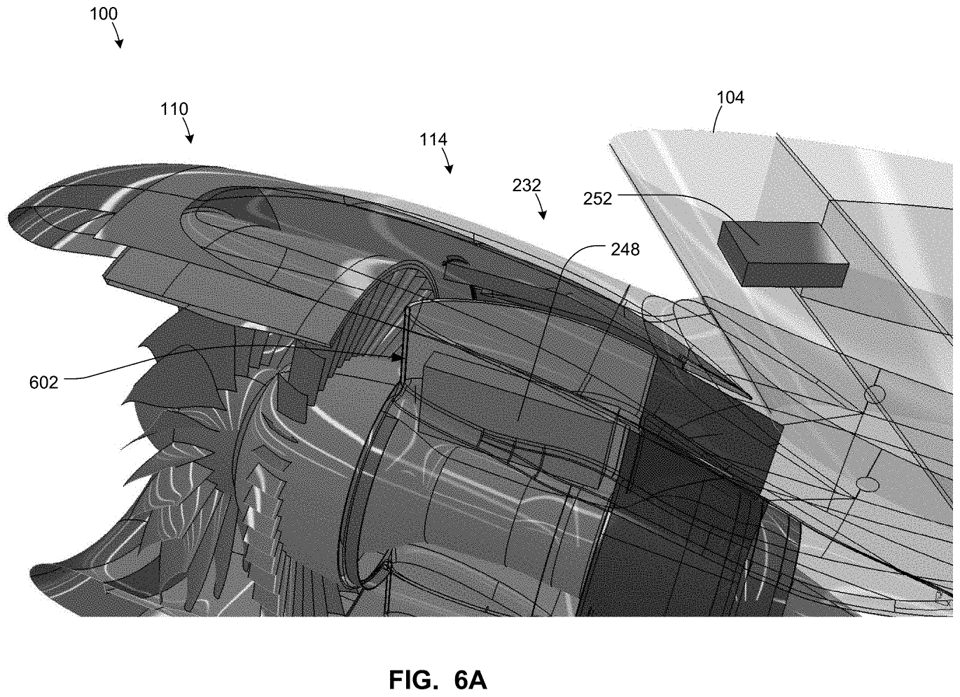

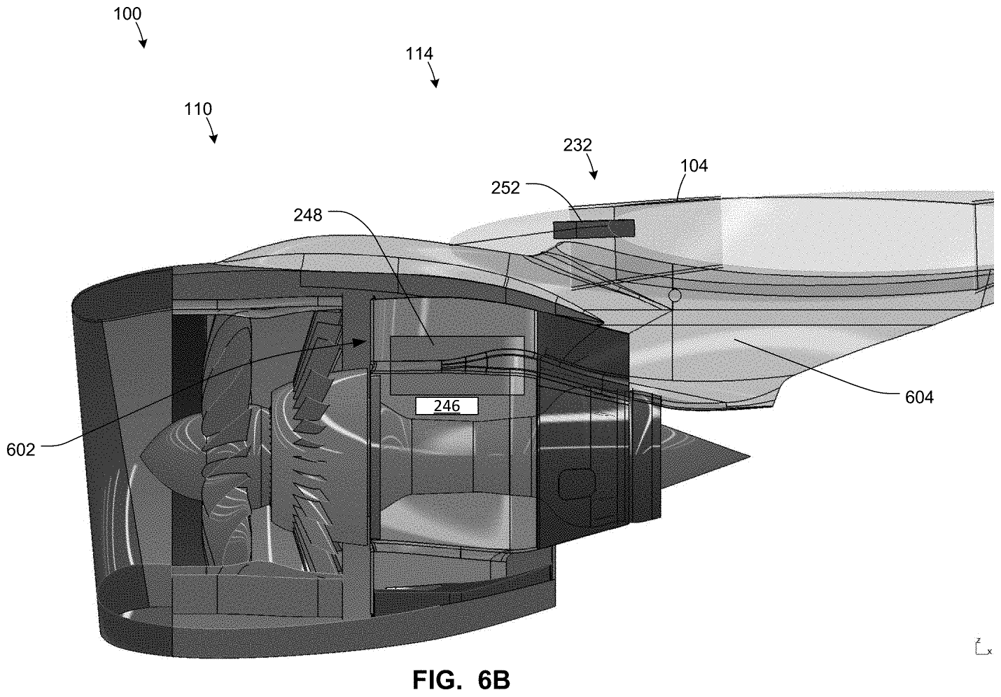

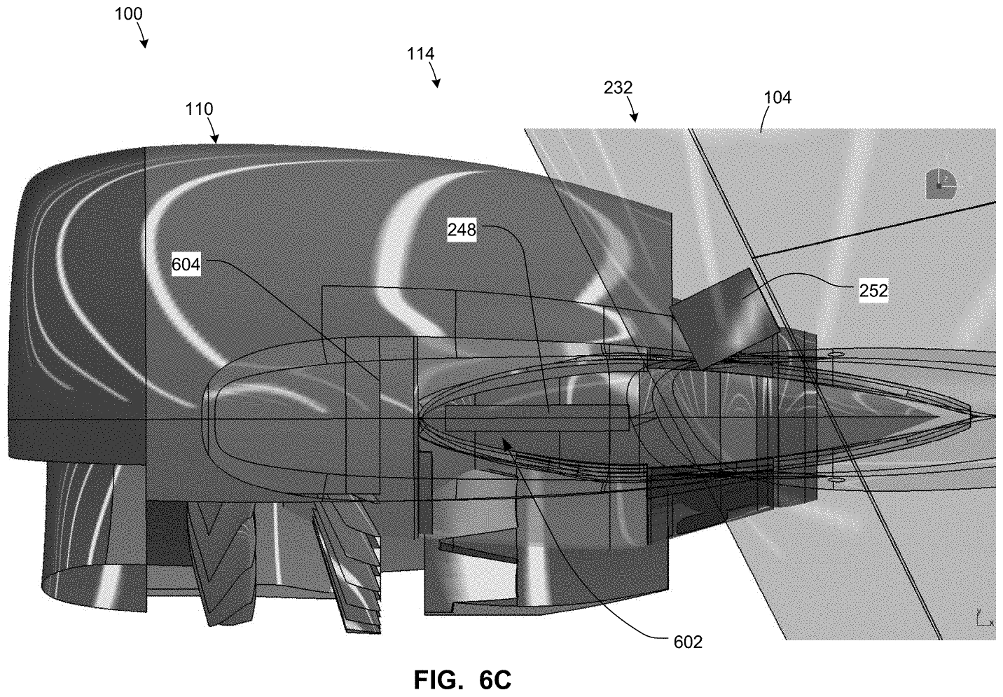

FIGS. 6A is a perspective, cutaway view of the aircraft engine 110 of FIGS. 1-5. FIG. 6B is a side, cutaway view of the aircraft engine 110 of FIG. 6A. FIG. 6C is a top, cutaway view of the aircraft engine 110 of FIG. 6C. In the illustrated example, at least some components of the primary cooling system 232 disclosed herein are located in aircraft engine 110 (e.g., turbofan engines) of the aircraft 100. For example, the VC compressor 246 and the condenser 248 are located in an upper bifurcation 602 of the aircraft engine 110. Additionally, at least some components of the primary cooling system 232 are located in the wing 104. For example, the evaporator 252 of the primary cooling system 232 is located or housed in the wing 104 of the aircraft 100. Alternatively, the evaporator 252 can be housed in a pylon 604 of the aircraft 100.

Additionally, the first supply air passageway 242a (FIG. 2) downstream from the evaporator working fluid outlet 252b can be routed along the wing 104 and to the fuselage 102. The supply air in the first supply air passageway 242a downstream from the evaporator working fluid outlet 252b is relatively cool air having a temperature of between approximately 10° F. and 160° F. The cooler temperature air flowing through the first supply air passageway 242a and to the ECS 201 reduces heating concerns in the first wing 104, thus, the wing 104 does not require additional insulation and/or other heat deterrent components, thereby reducing manufacturing costs and/or reducing weight, which increases aircraft engine efficiency.

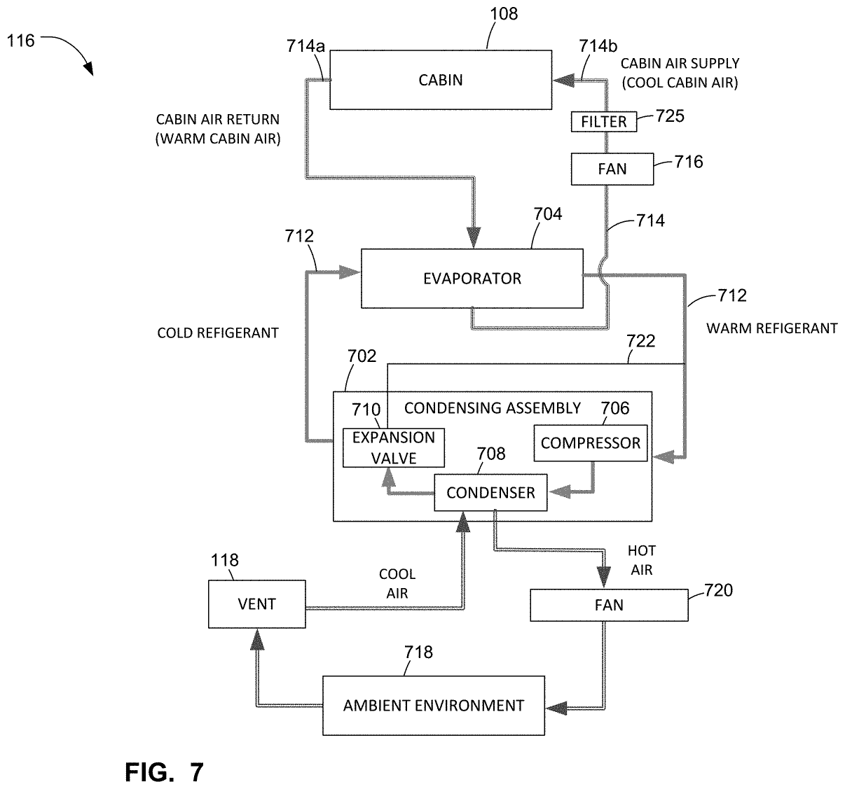

FIG. 7 is a schematic illustration of the auxiliary aircraft system 116 of FIG. 1. To meet cooling requirements during passenger boarding and prior to starting the aircraft engines 110, 112 and activation of the primary cooling system 232, the aircraft 100 includes the auxiliary aircraft system 116. The auxiliary aircraft system 116 cools or reduces a temperature of the cabin air to a predetermined temperature (e.g., between approximately 45° F. and 85° F.).

The auxiliary aircraft system 116 includes a condensing assembly 702 and an evaporator 704. The condensing assembly 702 includes a compressor 706, a condenser 708 and an expansion valve 710. The auxiliary aircraft system 116 includes a closed loop, vapor-compression cycle refrigeration system (e.g., a second refrigeration system) that employs a working fluid (e.g., a refrigerant such as R134a) to reduce a temperature of the cabin air. The working fluid flows through the condensing assembly and the evaporator via a closed loop, working fluid passageway 712 (e.g., a conduit, a duct, hoses, etc.).

The auxiliary aircraft system 116 recirculates and cools cabin air via a recirculation passageway 714. The recirculation passageway 714 includes a recirculation inlet 714a that draws cabin air from the cabin and a recirculation outlet 714b that provides air conditioned cabin air to the cabin 108. The recirculation passageway 714 includes a fan 716 to draw cabin air from the recirculation inlet 714a and causes the cabin air to flow towards the recirculation outlet 714b. The recirculation passageway 714 flows through the evaporator 704, which cools the cabin air to a desired temperature. The auxiliary aircraft system 116 recirculates the cabin air and can draw air through doors of the aircraft and/or outflow valves to refresh the recirculating air. If the doors are closed and/or outside air cannot flow into the cabin 108, the auxiliary aircraft system 116 recirculates the cabin air via the recirculation passageway 714. The auxiliary aircraft system 116 includes a filter 725 (e.g., a high-efficiency particulate air (HEPA) filter and/or other filters) to filter (e.g., particulate from) the air prior to providing the air to the cabin 108. The filter 725 is positioned or interposed in the recirculation passageway 714. In some examples, the filter 725 can be provided adjacent (e.g., at or downstream from) the recirculation outlet 714b.

During operation, the auxiliary aircraft system 116 cools the cabin air to a desired temperature. The auxiliary aircraft system 116 includes a closed loop, vapor-compression cycle cooling system that employs a working fluid (e.g., refrigerant) to cool cabin air from the cabin 108. The vapor-cycle begins with the compressor 706 receiving the working fluid from the evaporator 704 in a superheated vapor state (e.g., a gas) having a relatively low pressure. The compressor 706 compresses the superheated vapor to provide a high pressure, high temperature vapor to the condenser 708. The condenser 708 reduces a temperature of the working fluid by drawing ambient air from an ambient environment 718 via a fan 720. For example, the fan 720 draws ambient air (e.g., outside air) from the vent 118 (FIG. 1) formed in the fuselage 102. The cool, ambient air drawn into the condenser 708 extracts heat from the working fluid flowing through the condenser 708 to reduce a temperature of the working fluid, which causes the working fluid to convert to a saturated liquid. As a result, the condenser provides a provides a high pressure, cool temperature liquid (e.g., a saturated liquid/vapor mixture) to the expansion valve 710. The heated air from the condenser 708 is expelled to the ambient environment 718. In some examples, the heated air from the fan 720 is dumped overboard from the fuselage 102. In some examples, the heated air from the fan 720 is channeled to a pack bay area of the aircraft 100. In some examples, the ambient environment 718 is a pack bay area of the fuselage 102.

The expansion valve 710 modules a flow of the working fluid from the condenser 708 to cause the working fluid to decrease in pressure, which causes the working fluid to convert to a low pressure, cold liquid. To modulate the flow of the working fluid through the expansion valve 710 and control the temperature of the working fluid, the expansion valve employs a sensing line 722 (e.g., a sensing bulb) that measures or detects a temperature of the working fluid exiting the evaporator 704. Based on the sensed temperature, the expansion valve 710 moves between an open position (e.g., a fully open position) to increase a working fluid flow rate through the expansion valve 710 and a closed position (e.g., a fully closed position) to reduce a working fluid flow rate through the expansion valve 710. For example, if the temperature of the working fluid exiting the evaporator 704 sensed by the sensing line 722 exceeds a temperature threshold, the expansion valve 710 moves to an open position to increase a working fluid flow rate through the expansion valve. Likewise, if the temperature of the working fluid exiting the evaporator 704 sensed by the sensing line 722 does not exceed the temperature threshold, the expansion valve 710 moves to a closed position to reduce a working fluid flowrate through the expansion valve 710. The expansion valve 710 provides a low pressure, cold working fluid to the evaporator 704. As the working fluid flows through the evaporator 704 via the working fluid passageway 712, the working fluid extracts heat from the cabin air flowing through the evaporator 704 via the recirculation passageway 714. In turn, the working fluid increases in temperature and converts to a superheated vapor having a low pressure as it exits the evaporator outlet and returns to the compressor 706. Additionally, the cabin air is cooled as it passes through the evaporator 704 and returns to the cabin 108 via the recirculation outlet 714b. In some examples, the auxiliary aircraft system 116 can be configured to provide cooled cabin air having a temperature between approximately 45° F. and 85° F.

The auxiliary vapor-cycle systems disclosed herein are relatively small in size and require only a supply of power from an APU. For example, an auxiliary vapor-cycle system can be a mini-split unit located in an empty pack bay. As a result, aircraft employing the auxiliary aircraft system 116 can employ smaller sized auxiliary power units, thereby reducing aircraft weight. In other words, the auxiliary aircraft system 116 can be used in place of the relatively large air conditioning pack units stored in a pack bay area of an aircraft. Additionally, cooling systems disclosed herein enable use of smaller APUs. Additionally, the auxiliary vapor-cycle system can be configured as heat pump. In this manner, the auxiliary vapor-cycle system can provide a cooling mode to reduce a temperature of cabin air or a heating mode to increase a temperature of cabin air. The auxiliary vapor-cycle system can employ a reversing valve to switch between a vapor-cycle for cooling the cabin air or a vapor-cycle for heating the cabin air. For example, in the cooling mode, the auxiliary vapor-cycle system can reduce cabin air temperature from approximately between 85° F. and 100° F. to approximately between 65° F. and 80° F. For example, in the heating mode, the auxiliary vapor-cycle system can increase cabin air temperature from approximately between 0° F. and 50° F. to approximately between 65° F. and 85° F.

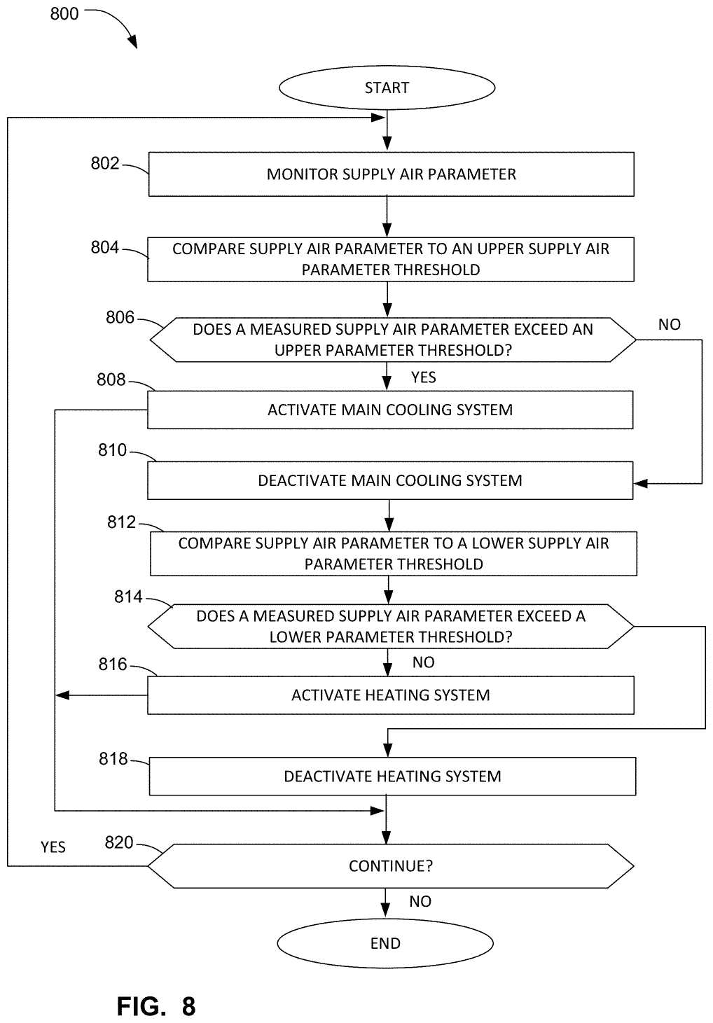

FIG. 8 is a flowchart representative of an example method 800 that may be implemented with the primary aircraft system 114 of FIG. 2 and/or a control system such as the system controller 280 of FIG. 2. For purposes of discussion, the example method 800 of FIG. 8 is described in connection with the primary aircraft system 114 and the system controller 280 of FIG. 2. In this manner, each of the example operations of the example method 800 of FIG. 8 is an example manner of implementing a corresponding one or more operations performed by one or more of the blocks of the example system controller 280 of FIG. 2. In this example, the method may be implemented using machine readable instructions that comprise a program for execution by a processor such as the processor 1100 shown in FIG. 11. The machine readable instructions may be one or more executable programs or portion(s) of an executable program for execution by a computer processor such as the processor 1112 shown in the example processor platform 1100 discussed below in connection with FIG. 11. The program may be embodied in software stored on a non-transitory computer readable storage medium such as a CD-ROM, a floppy disk, a hard drive, a DVD, a Blu-ray disk, or a memory associated with the processor 1112, but the entire program and/or parts thereof could alternatively be executed by a device other than the processor 1112 and/or embodied in firmware or dedicated hardware. Further, although the example program is described with reference to the flowchart illustrated in FIG. 8, many other methods of implementing the example system controller 280 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

The machine readable instructions described herein may be stored in one or more of a compressed format, an encrypted format, a fragmented format, a compiled format, an executable format, a packaged format, etc. Machine readable instructions as described herein may be stored as data (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement a program such as that described herein.

In another example, the machine readable instructions may be stored in a state in which they may be read by a computer, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, the disclosed machine readable instructions and/or corresponding program(s) are intended to encompass such machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example process of FIG. 8 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

Turning in detail to FIG. 8, the system controller 280 monitors a parameter of the supply air provided by the supply air system 230 (block 802). To monitor a system parameter, the system controller 280 receives one or more signals from the sensors 276a-e throughout the fan air passageway 240 and/or supply air passageways 242 and 242a-c and/or one or more signals from the sensors 277a-d throughout the primary cooling passageways 247, 249, 251, 253. The system controller 280 receives the signals via the I/O module 290. In some examples, system controller 280 can measure system parameters including fan air temperature, the fan air moisture, fan air humidity, supply air temperature, supply air pressure, altitude, and/or any other parameter of the supply air system 230 and/or the primary cooling system 232. The upper threshold valve can be stored in the database 296 and/or the upper threshold value can be based on other operating conditions (e.g., speed, altitude, passenger count, etc.) of the aircraft 100.

The system controller 280 compares the measured parameter to an upper supply air parameter threshold. (block 804). For example, the system controller 280 can compare, via the comparator 288, a temperature of the supply air received via the sensor 276a, 276b and/or 276c to an upper supply air temperature threshold value retrieved from a look-up table or storage stored in the database 296. The comparator 288 compares the measured temperature value of the supply air relative to an upper supply air temperature threshold stored in the database 296. In some examples, the system controller 280 can compare, via the comparator 288, a pressure of the supply air measured via the sensor 276a, 276b and/or 276c to an upper supply air pressure threshold value retrieved from a look-up table or storage stored in the database 296. The comparator 288 compares the measured pressure value of the supply air relative to an upper supply air pressure threshold stored in the database 296.

The system controller 280 then determines if the measured supply air parameter measured by, for example, the sensor 276a, 276b and/or 276c exceeds the upper parameter threshold (block 806). For example, if the system controller 280 determines at block 806 that the measured supply air temperature exceeds the upper temperature threshold, the system controller 280 activates the primary cooling system 232 (block 808). To activate the primary cooling system 232, the air temperature regulator 284 activates or engages the clutch 264 with the VC compressor 246, which causes the VC compressor 246 to operate. In turn, the air temperature regulator 284 receives one or more signals representative of a working fluid parameter (e.g., temperature) from the sensors 277a, 277b, 277c and/or 277d and modulates fan air flow through the condenser 248 via the valve 270e and/or the expansion valve 250 to achieve a working fluid parameter(s) through the evaporator 252 that provides supply air to the ECS 201 at a preset or desired temperature. For example, the supply air regulator 282 can determine and/or receive a preset or desired temperature (e.g., between 45° F. and 85° F.) for the supply air and/or the air temperature regulator 284 can determined the working fluid parameters for given supply air temperature from one or more look-up tables stored in the database 296.

If the system controller 280 determines at block 806 that the measured supply air temperature does not exceed the upper temperature threshold, the system controller 280 deactivates the primary cooling system 232 (block 810). To deactivate the primary cooling system 232, the air temperature regulator 284 commands the clutch 264 to operatively detach from VC compressor 246 to prevent operation of the VC compressor 246.

In some examples, the system controller 280 can monitor supply air pressure to determine if the supply air is at a desired supply air pressure for pressurizing the cabin 108. When the system controller 280 monitors supply air pressure as a parameter of the supply air, the system controller 280 determines at block 806 if a measured supply air pressure exceeds an upper pressure threshold. If the system controller 280 determines that the measured supply air pressure exceeds an upper pressure threshold, the process returns to block 820. If the system controller 280 determines at block 806 that a measured supply air pressure does not exceed an upper pressure threshold, the process returns to block 812.

The system controller 280 compares the measured supply air parameter to a lower supply air parameter threshold. (block 812). For example, the system controller 280 can compare, via the comparator 288, a temperature and/or pressure of the supply air received via the sensor 276a, 276b and/or 276c to a lower supply air temperature and/or pressure threshold value retrieved from a look-up table or storage stored in the database 296.

The system controller 280 then determines if the measured supply air parameter (e.g., a temperature and/or pressure) measured by, for example, the sensor 276a, 276b and/or 276c exceeds a lower parameter threshold (block 814). If the system controller 280 determines at block 814 that the measured supply air parameter (e.g., a temperature and/or pressure) does not exceed the lower parameter threshold, the supply air regulator 282 and/or the valve operator 286 activates the recirculation system 243 (block 816). To activate the recirculation system 243, the valve operator 286 moves the valve 270c to an open position, which causes supply air from the SA compressor outlet 238b to return to the SA compressor inlet 238a via the recirculation passageway 243a. In some examples, the system controller 280 receives one or more signals representative of the supply air from the sensor 276a and causes the valve operator 286 to modulate the valve 270c to achieve supply air having a desired supply air parameter (e.g., a temperature and/or pressure).

If the system controller 280 determines at block 814 that the measured supply air parameter (e.g., a temperature and/or pressure) exceeds the lower parameter threshold, the supply air regulator 282 and/or the valve operator 286 deactivates the recirculation system 243 (block 818) To activate the recirculation system 243, the valve operator 286 moves the valve 270c to a closed position to prevent supply air recirculation from the SA compressor outlet 238b to return to the SA compressor inlet 238a via the recirculation passageway 243a.

The system controller 280 determines if the primary aircraft system 114 should continue (block 820). For example, the system controller 280 can determine to discontinue monitoring the primary aircraft system 114 based on an operating condition of the aircraft engine 110. If the system controller 280 determines at block 820 that primary aircraft system 114 is to continue (e.g., the primary aircraft system 114 should persist), control returns to block 802. If the system controller 280 determines that the primary aircraft system 114 should not continue (block 820), the program 800 ends.

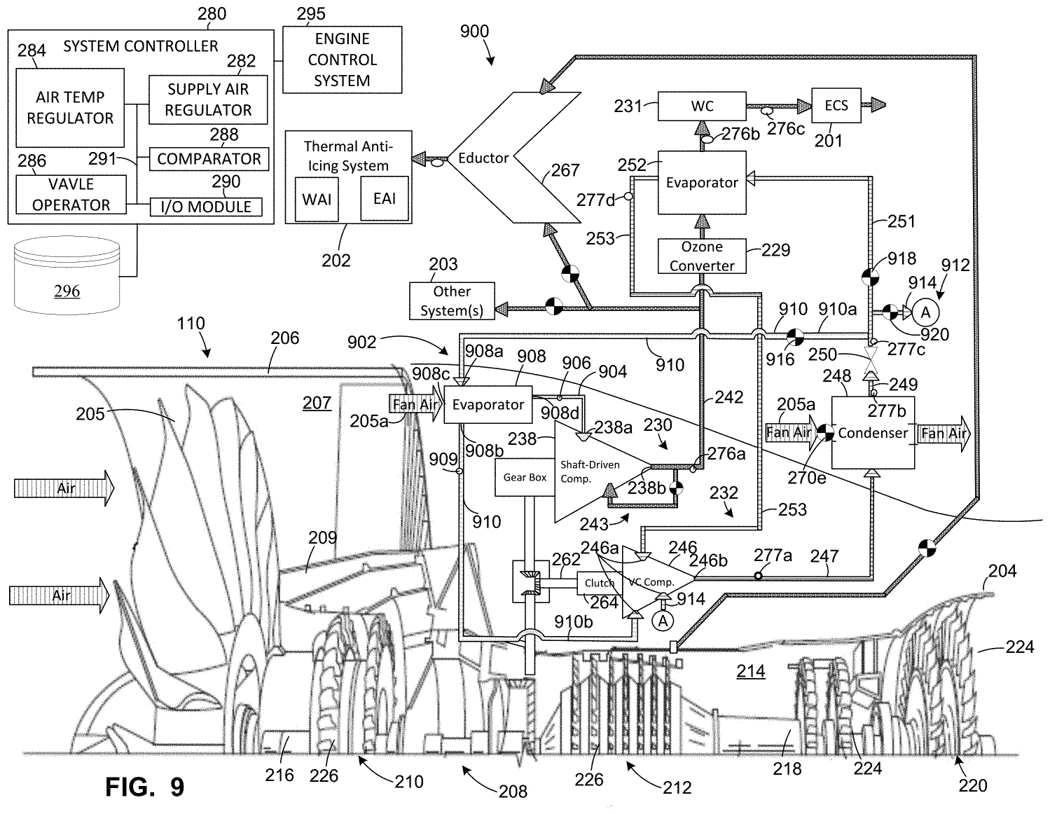

FIG. 9 illustrates another example primary aircraft system 900 described herein that can be implemented with the aircraft 100 of FIG. 1 Those components of the primary aircraft system 900 that are substantially similar or identical to the components of the primary aircraft system 114 described above and that have functions substantially similar or identical to the functions of those components will not be described in detail again below. Instead, the interested reader is referred to the above corresponding descriptions. To facilitate this process, the same reference numbers will be used for like structures.

The primary aircraft system 900 includes a supply air system 230, a primary cooling system 232, the recirculation system 243, and a precooling system 902. The precooling system 902 reduces a temperature of the fan air 205a upstream from the supply air system 230 (e.g., prior to the fan air 205a flowing to the supply air system 230). Specifically, the precooling system 902 reduces a temperature of the fan air 205a prior to the fan air 205a flowing into the SA compressor inlet 238a of the SA compressor 238.

The precooling system 902 provides an inlet passageway 904 to allow the fan air 205a to flow to the SA compressor inlet 238a. In some examples, the inlet passageway 904 can be provided in place of the fan air passageway 240 (FIG. 2). In some examples, the inlet passageway 904 can be replaced with the fan air passageway 240 and/or can include an adjustable guide vane 241 (FIG. 2) to adjust (e.g., increase or decrease) a flow rate (e.g., a mass flow rate) of the supply air to the SA compressor 238. The inlet passageway 904 includes one or more sensors 906 that is/are configured to measure one or more parameters of the fan air 205a. For example, the one or more sensor(s) 906 can measure fan air temperature, fan air pressure, fan air humidity and/or any other parameter(s) of the fan air 205a.

To cool the fan air 205a, the precooling system 902 includes an evaporator 908. Specifically, the evaporator 908 employs working fluid (e.g., refrigerant) from the primary cooling system 232 to cool (e.g., extract heat from or reduce a temperature of) the fan air 205a flowing through the evaporator 908 upstream from the SA compressor inlet 238a. In other words, the precooling system 902 uses working fluid that is part of the working fluid circuit of the primary cooling system 232. For example, the precooling system 902 includes a precooling passageway 910 to route working fluid through the evaporator 908. The precooling passageway 910 includes a first precooling passageway 910a that fluidly couples the working fluid exiting the expansion valve outlet 250b of the expansion valve 250 to an evaporator working fluid inlet 908a of the evaporator 908 (e.g., a supply line). The precooling passageway 910 includes a second precooling passageway 910b to fluidly couple the working fluid exiting a precooling evaporator working fluid outlet 908b of the precooling evaporator 908 to the VC compressor inlet 246a (e.g., a return line). Thus, the precooling evaporator 908 receives a working fluid from the primary cooling system 232 via the first precooling passageway 910a (e.g., a conduit, a duct, a hose, etc.) and returns the working fluid to a VC compressor inlet 246a of a VC compressor 246 via the second precooling passageway 910b. The fan air 205a passes through the precooling evaporator 908 via an evaporator fan air inlet 908c and an evaporator fan air outlet 908d. The fan air 205a does not mix with the working fluid. To the contrary, the working fluid passes through a conduit (e.g., coiled tubes) of the evaporator 908 and the fan air 205a passes over or across the conduit, where the conduit is fluidly isolated from the fan air 205a.

The primary aircraft system 900 of FIG. 9 includes an ancillary system 912. The ancillary system 912 includes an ancillary working fluid passageway 914 to fluidly couple and/or route the working fluid of the primary cooling system 232 to other system(s) or component(s) of the aircraft 100 such as, for example, a casing of the low-pressure turbine 220 and/or the high-pressure turbine 222 and/or any other component(s) of the aircraft engine 110 and/or the aircraft 100. The ancillary working fluid passageway 914 enables working fluid from the primary cooling system 232 to cool other components of the aircraft 100 and routes or returns the working fluid to the VC compressor inlet 246a. In some examples, the ancillary system 912 includes an evaporator interposed in the ancillary working fluid passageway 914. The primary cooling passageways 247, 249, 251, 253, the precooling passageway 910 and the ancillary working fluid passageway 914 provide a closed loop system for the working fluid. In other words, the working fluid does not mix with the supply air, fan air and/or any other fluid(s).

To control flow of working fluid in the precooling passageway 910, the precooling passageway employs a valve 916. The valve 916 is interposed in the precooling passageway downstream from the expansion valve 250 to control fluid flow through the precooling passageway 910 between the expansion valve outlet 250b and the precooling evaporator working fluid inlet 908a. Additionally, unlike the primary cooling system 232 of FIG. 2, the primary cooling system 232 of FIG. 9 includes a valve 918 positioned downstream from the expansion valve 250. Specifically, the valve 918 controls fluid flow between the expansion valve outlet 250b and the evaporator working fluid inlet 252a. For example, in some instances, the working fluid can be routed through the precooling passageway 910 via the precooling valve 916 and the working fluid can be prevented from flowing (e.g., blocked) through the primary cooling passageways 251 and 253. The ancillary working fluid passageway 914 also includes a valve 920 downstream from the expansion valve outlet 250b. For example, the valve 920 can be operated to control (e.g., allow or prevent) fluid flow through the ancillary working fluid passageway 914 from the expansion valve outlet 250b to the VC compressor inlet 246a.

Each of the valves 916-920 operates independently of the other valves and can operate between an open position (e.g., a fully open position or state) to allow working fluid to flow through the respective valves 916-920 and a closed position (e.g., a fully closed position or state) to prevent or restrict working fluid flow through the respective valves 916-920. The valves 916-920 can include a pressure-regulating valve (PRV), a pressure-regulating shut off valve (PRSOV), a shut off valve (SOV), a high pressure shut off valve (HPSOV), a back-flow prevention valve, a multi-directional valve, a three-way valve, a four-way valve, etc., and/or any other air control device.

To measure parameters or characteristics of the primary aircraft system 900, the primary aircraft system 900 includes one or more sensors 906, 276a-e, 277a-d and 909 (e.g., temperature sensors, pressure sensors, flow sensors, humidity sensors, etc.) to measure temperature, pressure, water content, humidity, and/or any other parameter or characteristic of the primary aircraft system 900. For example, one or more sensor(s) 906 is/are coupled to the inlet passageway 904 of the precooling system 902 to measure temperature, pressure and/or flowrate of the fan air 205a flowing to the SA compressor inlet 238a. One or more sensors 909 is/are coupled to the precooling passageway 910 (e.g., the second precooling passageway 910b) downstream from the precooling evaporator working fluid outlet 908b to measure a parameter (e.g., a temperature, a pressure, etc.) of the working fluid exiting the precooling evaporator 908.

In operation, to control operation of the primary aircraft system 900, the primary aircraft system 900 includes a system controller 280. The system controller 280 is communicatively coupled to one or more the sensors 276a-e, 277a-d, 906, 909, the valves 270a-e, 918-920, the gearbox 263a, the clutch 264, and/or any other device that controls and/or monitors various parameters (e.g., mass flow rate, pressure, temperature, etc.) of the primary aircraft system 900.

The I/O module 290 receives signals from one or more sensors 906 measuring one or more parameters of the fan air 205a, one or more sensors 276a-e measuring one or more parameters of the supply air system 230, and one or more sensors 277a-d, measuring one or more parameters of the working fluid of the primary cooling system 232, and one or more sensors 909 measuring one or more parameters of the working fluid of the precooling system 902. The comparator 288 compares the measured values of the parameter(s) to one or more thresholds or threshold ranges (e.g., stored in a database accessible by the system controller 280). Based on whether the parameter(s) satisfy the thresholds or threshold ranges, the valve operator 286 can operate one or more of the valves 270a-e to result in optimal cabin supply air pressure and/or temperature to the ECS 201, optimal supply air pressure and/or temperature for the TAI 202, and/or optimal supply air pressure and/or temperature for the other aircraft system(s) 203. For example, the valve operator 286 controls operating states of the valves 270a-e. The supply air regulator 282 controls the gearbox 263a (to control the speed of the SA compressor 238) and the adjustable guide vane 241, thereby controlling at least one of temperature, pressure, and/or flow rate of the air at the SA compressor outlet 238b. The air temperature regulator 284 controls the clutch 264 between a first or engaged position to operate the VC compressor 246 and a second or disengaged position to operatively decouple the VC compressor 246 from the second driveshaft 262 and/or the primary driveshaft 256.

Additionally, the air temperature regulator 284 controls one or more valves 916, 918, 920 to provide cold working fluid to the evaporator 252 of the primary cooling system 232, the evaporator 908 of the precooling system 902, and/or the ancillary system 912. For example, the air temperature regulator 284 receives a measured temperature of the fan air 205a via the sensor 906 and compares, via the comparator 288, the measured temperature to a fan air temperature threshold that can be stored, retrieved or otherwise obtained from a look-up table of the database 296. If the system controller 280 determines that the measured fan air does not exceed (e.g., is less than) the temperature threshold, the valve operator 286 commands the valve 916 to move to a closed position to deactivate the precooling system 902 (e.g., prevent working fluid from flowing from the expansion valve outlet 250b to the precooling evaporator 908). When the valve 916 is in the closed position, fan air 205a flows through the evaporator fan air inlet 908c and the evaporator fan air outlet 908d and to the SA compressor inlet 238a unaffected by the precooling evaporator 908 because the valve 916 prevents flow of the working fluid through the precooling passageway 910. In other words, the working fluid does not act on the fan air 205a flowing through the precooling evaporator 908 and to the inlet passageway 904 when the valve 916 is in a closed position (i.e., that prevents working fluid from flowing though the precooling passageway 910).

If the system controller 280 determines that the measured fan air temperature exceeds (e.g., is greater than) the temperature threshold, the valve operator 286 commands the valve 916 to move to an open position to activate the precooling system 902 (e.g., allow working fluid flow through the precooling passageway 910). When the valve 916 is in the open position, working fluid from the expansion valve outlet 250b flows through the first precooling passageway 910a to the precooling evaporator working fluid inlet 908a, through the precooling evaporator 908, and from the precooling evaporator working fluid outlet 908b to the VC compressor inlet 246a via the second precooling passageway 910b. Based on the measured temperatures of the various fluids (e.g., the fan air 205a, the working fluid and the supply air) from the sensors 276a-e, 277a-d, 906 and 909 and comparison of the one or more fluids to respective thresholds, the valve operator 286 controls operation (e.g., modulates) one or more valves 916, 250 and/or 270e to achieve fan air 205a at the SA compressor inlet 238a that is at a desired or target temperature, achieve supply air at the ECS 201 to have a desired or target temperature.

FIGS. 10A and 10B illustrates another example primary aircraft system 1000 described herein that can be implemented with the aircraft 100 of FIG. 1 Those components of the primary aircraft system 1000 that are substantially similar or identical to the components of the primary aircraft system 114 described above and that have functions substantially similar or identical to the functions of those components will not be described in detail again below. Instead, the interested reader is referred to the above corresponding descriptions. To facilitate this process, the same reference numbers will be used for like structures.

The primary aircraft system 1000 includes a supply air system 230 and a primary cooling and heating system 1002. The primary cooling and heating system 1002 can be used to vary (e.g., increase or decrease) a temperature of the supply air exiting the SA compressor 238. The primary aircraft system 1000 is substantially similar to the primary aircraft system 114 of FIG. 2 except that the cooling and heating system 1002 of FIG. 10 can be configured as an air conditioner to cool the supply air from the supply air system 230 or a heat pump to heat the supply air from the supply air system 230. For example, the cooling and heating system 1002 can be employed to reduce a supply air temperature of the supply air exiting the SA compressor outlet 238b from a first temperature to a second temperature less than the first temperature as the supply air flows through the evaporator 252 and to the ECS 201. Likewise, the cooling and heating system 1002 can be employed to increase a supply air temperature of the supply air exiting the SA compressor outlet 238b from a first temperature to a second temperature that is greater than the first temperature as the supply air flows through the evaporator 252 and to the ECS 201.

To activate the cooling and heating system between a cooling mode 1004 to cool the supply air exiting the SA compressor outlet 238b as shown in FIG. 10A and a heating mode 1006 to heat the supply air exiting the SA compressor outlet 238b as shown in FIG. 10B, the cooling and heating system 1002 employs a reversing valve 1008. The reversing valve is fluidly coupled to the primary cooling passageway 247, the primary cooling passageway 253, the VC compressor inlet 246a and the VC compressor outlet 246b. The reversing valve moves (e.g., rotates 90 degrees) between a first position 1010 to activate the cooling mode 1004 as shown in FIG. 10A and a second position 1012 to activate the heating mode 1006 shown in FIG. 10B.

Referring to FIG. 10A, in the cooling mode 1004, the cooling and heating system 1002 operates substantially similar to the primary cooling system 232 of FIGS. 2 and 3. In the cooling mode 1004, the working fluid flows from the VC compressor outlet 246b to the primary cooling passageway 247 via the reversing valve 1008. The working fluid continues to flow to the condenser 248 via the primary cooling passageway 247, the expansion valve 250, the evaporator 252 and returns to the VC compressor inlet 246a via the primary cooling passageway 253 and the reversing valve 1008. The operation of the cooling and heating system 1002 will not be described herein. The interested reader can refer to FIGS. 2 and 3.

Referring to FIG. 10B, in the heating mode 1006, the reversing valve 1008 reverses the flow direction of the working fluid compared to the direction of the working fluid when the cooling and heating system 1002 is in the cooling mode 1004 shown in FIG. 10A. For example, in the second position 1012, the reversing valve 1008 fluidly couples the VC compressor outlet 246b to the primary cooling passageway 253 and fluidly couples the primary cooling passageway 247 to the VC compressor inlet 246a.

In operation, the VC compress the working fluid to a high temperature and a high pressure (e.g., a superheated vapor) and the reversing valve 1008 routes the working fluid from the VC compressor outlet 246b to the evaporator working fluid outlet 252b via the primary cooling passageway 253. The working fluid flows through the evaporator 252 from the evaporator working fluid outlet 252b to the evaporator working fluid inlet 252a. In other words, the evaporator working fluid outlet 252b functions as inlet and the evaporator working fluid inlet 252a functions as an outlet. As the high pressure, high temperature working fluid flows through the evaporator 252 (in reverse direction) from the evaporator working fluid outlet 252b to the evaporator working fluid inlet 252a, the cooler supply air from the SA compressor outlet 238b flows through the evaporator supply air inlet 252c and the evaporator supply air outlet 252d and to the ECS 201. As the cool supply air flows between the evaporator supply air inlet 252c and the evaporator supply air outlet 252d, the supply air absorbs heat from the high temperature, high pressure working fluid flowing from the evaporator working fluid outlet 252b to the evaporator working fluid inlet 252a. The working fluid reduces temperature as it exits the evaporator working fluid inlet 252a and converts to a vapor and liquid mixture or state. The working fluid enters the expansion valve outlet 250b via the primary cooling passageway 251 and the expansion valve 250 modulates the working fluid flow through the expansion valve 250 to cause the working fluid to exit the expansion valve inlet 250a as a low pressure, low temperature liquid. The working fluid flows through the condenser 248 from the condenser working fluid outlet 248b to the condenser working fluid inlet 248a. Additionally, the fan air 205a has a temperature that is greater than the temperature of the working fluid exiting the expansion valve inlet 250a. Thus, as the fan air 205a flows through the condenser from the condenser air inlet 248c to the condenser air outlet 248d, the working fluid absorbs heat from the fan air 205a, causing the temperature of the fan air 205a to decrease and the temperature of the working fluid to increase. The working fluid exits the condenser working fluid inlet 248a as a low pressure, regulator temperature fluid. In some examples, the working fluid is a liquid and vapor mixture. The working fluid then flows to the reversing valve 1008 via the passageway 247. In turn, the reversing valve 1008 routes the working fluid to the VC compressor inlet 246a. Thus, the heat mode 1006 operates opposite to the cooling mode 1004. For example, in the heat mode 1006, the evaporator 252 functions similar to the condenser 248 of the cooling mode 1004, and the condenser 248 functions similar to the evaporator 252 of the cooling mode 1004.

To control the cooling and heating system 1002 of FIGS. 10A and 10B, the primary aircraft system 1000 includes the system controller 280. For example, the air temperature regulator 284 receives signals via the I/O module 290 representative of one or more parameters of the fan air 205a in the fan air passageway 240 via the sensors 276e and/or of the supply air in the first supply air passageway 242a via the one or more sensors 276a-c. The air temperature regulator 284 compares, via the comparator 288, the one or more parameters to one or more respective parameter thresholds in a lookup table stored in the database 296. For example, the air temperature regulator 284 measures a temperature of the fan air 205a via the sensor 276e and/or a temperature of the supply air via the sensors 276a-c. If the cooling/heating system determines that the measured temperature of the fan air and/or the supply air exceeds an upper temperature threshold, the air temperature regulator 284 commands the reversing valve 1008, via the valve operator 286, to move to the first position 1010 to activate the cooling mode 1004 as shown, for example, in FIG. 10A. Similarly, if the cooling/heating system determines that the measured temperature of the fan air and/or the supply air does not exceed a lower temperature threshold, the air temperature regulator 284 commands the reversing valve 1008, via the valve operator 286, to move to the second position 1012 to activate the heating mode 1006 as shown, for example, in FIG. 10B. If the air temperature regulator 284 determines that the measured temperature of the fan air and/or the supply air does not exceed an upper temperature threshold and does exceed the lower temperature threshold (i.e., the measured temperature is within the lower threshold and the upper threshold, the air temperature regulator 284 deactivates the cooling and heating system 1002. For example, the air temperature regulator 284 causes the clutch to disengage the primary driveshaft. In some examples, the recirculation system 243 can be employed to increase (e.g., boost) a pressure of the supply air.

FIG. 11 is a block diagram of an example processor platform 1100 structured to execute the instructions of FIG. 8 to implement the system controller 280 of FIGS. 2-5 and 9. The processor platform 1100 can be, for example, a server, a personal computer, a workstation, a self-learning machine (e.g., a neural network), a mobile device (e.g., a cell phone, a smart phone, or any other type of computing device.

The processor platform 1100 of the illustrated example includes a processor 1112. The processor 1112 of the illustrated example is hardware. For example, the processor 1112 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the supply air regulator 282, the air temperature regulator 284, the valve operator 286, the comparator 288, and the I/O module 290.

The processor 1112 of the illustrated example includes a local memory 1113 (e.g., a cache). The processor 1112 of the illustrated example is in communication with a primary memory including a volatile memory 1114 and a non-volatile memory 1116 via a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 1116 may be implemented by flash memory and/or any other desired type of memory device. Access to the primary memory 1114, 1116 is controlled by a memory controller.

The processor platform 1100 of the illustrated example also includes an interface circuit 1120. The interface circuit 1120 may be implemented by any type of interface standard, such as an Ethernet interface, a universal serial bus (USB), a Bluetooth® interface, a near field communication (NFC) interface, and/or a PCI express interface.

In the illustrated example, one or more input devices 1122 are connected to the interface circuit 1120. The input device(s) 1122 permit(s) a user to enter data and/or commands into the processor 1112. The input device(s) can be implemented by, for example, a keyboard, a button, a mouse, a touchscreen, a track-pad, a trackball, isopoint and/or a voice recognition system.

One or more output devices 1124 are also connected to the interface circuit 1120 of the illustrated example. The output devices 1124 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, and/or speaker. The interface circuit 1120 of the illustrated example, thus, typically includes a graphics driver card, a graphics driver chip and/or a graphics driver processor.

The interface circuit 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 1126. The communication can be via, for example, an Ethernet connection, a digital subscriber line (DSL) connection, a telephone line connection, a coaxial cable system, a satellite system, a line-of-site wireless system, a cellular telephone system, etc.

The processor platform 1100 of the illustrated example also includes one or more mass storage devices 1128 for storing software and/or data. Examples of such mass storage devices 1128 include floppy disk drives, hard drive disks, compact disk drives, Blu-ray disk drives, redundant array of independent disks (RAID) systems, and digital versatile disk (DVD) drives.

The machine executable instructions 1132 of FIG. 8 may be stored in the mass storage device 1128, in the volatile memory 1114, in the non-volatile memory 1116, and/or on a removable non-transitory computer readable storage medium such as a CD or DVD.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

The foregoing examples of the aircraft systems 200, 900 and 1000 can be employed with an aircraft and/or aircraft engine. Although each of the aircraft systems 200, 900 and 1000 disclosed above has certain features, it should be understood that it is not necessary for a particular feature of one example to be used exclusively with that example. Instead, any of the features described above and/or depicted in the drawings can be combined with any of the examples, in addition to or in substitution for any of the other features of those examples. One example's features are not mutually exclusive to another example's features. Instead, the scope of this disclosure encompasses any combination of any of the features. In some examples, a system disclosed in accordance with the teachings of this disclosure can have a combination of features from any of the systems 200, 900 and 1000, the supply air system 230, the primary cooling system 232, the auxiliary aircraft system 116, the precooling system 902 the ancillary system 912 and/or the cooling and heating system 1002 disclosed herein.

At least some of the aforementioned examples include one or more features and/or benefits including, but not limited to, the following:

In some examples, an aircraft system includes an air compressor operatively coupled to a turbine engine, the air compressor configured to generate compressed air at a first temperature. A vapor cycle system is configured to reduce the first temperature of the compressed air provided by the air compressor to a second temperature that is less than the first temperature.

In some examples, the vapor cycle system includes a vapor-cycle compressor.

In some examples, a first driveshaft coupled to the vapor-cycle compressor, the first driveshaft to be driven by a primary driveshaft driven by the turbine engine.

In some examples, the vapor cycle system includes a clutch to operatively couple and decouple the vapor-cycle compressor and the first driveshaft.

In some examples, the vapor-cycle compressor is driven by the turbine engine via the primary driveshaft when the clutch is engaged with the vapor-cycle compressor, and the vapor-cycle compressor is not driven when the clutch is disengaged with the vapor-cycle compressor.

In some examples, the vapor cycle system is configured to operate in a cooling mode or a heating mode, the vapor cycle system to decrease a temperature of a supply air to an environmental conditioning system when the vapor cycle system operates in the cooling mode, the vapor cycle system to increase a temperature of the supply air to the environmental conditioning system when the vapor cycle system operates in the heating mode.

In some examples, the vapor cycle system includes a reversing valve movable between a first position to operate the vapor cycle system in the cooling mode and a second position to operate the vapor cycle system in the heating mode.

In some examples, a system for an aircraft includes a supply air system to receive fan air and generate supply air for a cabin of the aircraft. A vapor-cycle system is to operate in at least one of a cooling mode or a heating mode, the vapor-cycle system to reduce a temperature the supply air when operating in the cooling mode, the vapor cycle system to increase a temperature of the supply air when operating in the heating mode.

In some examples, the supply air system includes a supply air compressor configured to receive fan air to generate the supply air.

In some examples, the supply air system includes a supply air compressor system and a vapor-cycle compressor, the supply air compressor and the vapor-cycle compress to be driven by an engine of the aircraft.

In some examples, a variable speed transmission is coupled to the supply air compressor and a clutch operatively coupled to the vapor-cycle compressor, the clutch to engage the vapor-cycle compressor to operatively couple the vapor-cycle compressor with the aircraft engine and disengage the vapor-cycle compressor to operatively decouple the vapor-cycle compressor with the engine.

In some examples, the vapor-cycle system includes a vapor-cycle compressor, a condenser, an evaporator and an expansion valve.

In some examples, the vapor-cycle system includes a precooling system that is to reduce a temperature of fan air upstream from a supply air compressor inlet of the supply air system.

In some examples, the precooling system employs an evaporator that is to receive a working fluid from the vapor-cycle system.

In some examples, the vapor-cycle compressor and the condenser are positioned in an upper bifurcation of the engine and the evaporator is positioned in at least one of pylon or a wing of the aircraft.

In some examples, the vapor-cycle system employs a working fluid including carbon dioxide.

In some examples, the vapor-cycle system includes a reversing valve movable between a first position and a second position, wherein the reversing valve to cause the vapor-cycle system to operate in a cooling mode when the reversing valve is in the first position to reduce a temperature of the supply air, and wherein the reversing valve is to cause the vapor-cycle system to operate in a heating mode when the reversing valve is in the second position to increase a temperature of the supply air.

In some examples, the vapor-cycle system is a closed loop system.

In some examples, a system for an aircraft includes a supply air system including a supply air compressor configured to receive fan air and generate a supply air for a cabin of the aircraft. A primary cooling system cools the supply air prior to the supply air flowing to the cabin during operation of an aircraft engine, the primary cooling system includes a first closed loop, vapor-cycle system. An auxiliary cooling system recirculates and cool the cabin air when the aircraft engine is not operating, the auxiliary cooling system includes a second closed loop, vapor-cycle system that is independent from the first closed loop, vapor-cycle system.

In some examples, the auxiliary cooling system is positioned in a pack bay area of a fuselage of the aircraft.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. An aircraft system comprising:
an air compressor operatively coupled to a turbine engine, the air compressor configured to generate compressed air at a first temperature; and
a vapor-cycle system configured to reduce the first temperature of the compressed air provided by the air compressor to a second temperature that is less than the first temperature.

2. The system as defined in claim 1, wherein the vapor-cycle system includes a vapor-cycle compressor.

3. The system as defined in claim 2, further including a first driveshaft coupled to the vapor-cycle compressor, the first driveshaft to be driven by a primary driveshaft driven by the turbine engine.

4. The system as defined in claim 3, wherein the vapor-cycle system includes a clutch to operatively couple and decouple the vapor-cycle compressor and the first driveshaft.

5. The system as defined in claim 4, wherein the vapor-cycle compressor is driven by the turbine engine via the primary driveshaft when the clutch is engaged with the vapor-cycle compressor, and the vapor-cycle compressor is not driven when the clutch is disengaged with the vapor-cycle compressor.

6. The system as defined in claim 1, wherein the vapor-cycle system is configured to operate in a cooling mode or a heating mode, the vapor-cycle system to decrease a temperature of a supply air to an environmental conditioning system when the vapor-cycle system operates in the cooling mode, the vapor-cycle system to increase a temperature of the supply air to the environmental conditioning system when the vapor-cycle system operates in the heating mode.

7. The system as defined in claim 6, wherein the vapor-cycle system includes a reversing valve movable between a first position to operate the vapor-cycle system in the cooling mode and a second position to operate the vapor-cycle system in the heating mode.

8. A system for an aircraft, the system comprising:
a supply air system to receive fan air and generate supply air for a cabin of the aircraft; and
a vapor-cycle system to operate in at least one of a cooling mode or a heating mode, the vapor-cycle system to reduce a temperature the supply air when operating in the cooling mode, the vapor-cycle system to increase a temperature of the supply air when operating in the heating mode.

9. The system as defined in claim 8, wherein the supply air system includes a supply air compressor configured to receive the fan air to generate the supply air.

10. The system as defined in claim 8, wherein the supply air system includes a supply air compressor system and a vapor-cycle compressor, the supply air compressor and the vapor-cycle compressor to be driven by an engine of the aircraft.

11. The system as defined in claim 10, further including a variable speed transmission coupled to the supply air compressor and a clutch operatively coupled to the vapor-cycle compressor, the clutch to engage the vapor-cycle compressor to operatively couple the vapor-cycle compressor with the engine and disengage the vapor-cycle compressor to operatively decouple the vapor-cycle compressor with the engine.

12. The system as defined in claim 8, wherein the vapor-cycle system includes a vapor-cycle compressor, a condenser, an evaporator and an expansion valve.

13. The system as defined in claim 12, wherein the vapor-cycle system includes a precooling system that is to reduce a temperature of the fan air upstream from a supply air compressor inlet of the supply air system.

14. The system as defined in claim 13, wherein the precooling system employs a precooling evaporator that is to receive a working fluid from the vapor-cycle system.

15. The system as defined in claim 12, wherein the vapor-cycle compressor and the condenser are positioned in an upper bifurcation of an engine of the aircraft and the evaporator is positioned in at least one of a pylon or a wing of the aircraft.

16. The system as defined in claim 12, wherein the vapor-cycle system employs a working fluid including carbon dioxide.

17. The system as defined in claim 8, wherein the vapor-cycle system includes a reversing valve movable between a first position and a second position, wherein the reversing valve to cause the vapor-cycle system to operate in a cooling mode when the reversing valve is in the first position to reduce a temperature of the supply air, and wherein the reversing valve is to cause the vapor-cycle system to operate in a heating mode when the reversing valve is in the second position to increase a temperature of the supply air.

18. The system as defined in claim 8, wherein the vapor-cycle system is a closed loop system.

19. A system for an aircraft, the system comprising:
a supply air system including a supply air compressor configured to receive fan air and generate a supply air for a cabin of the aircraft;
a primary cooling system to cool the supply air prior to the supply air flowing to the cabin during operation of an engine, the primary cooling system includes a first closed loop, vapor-cycle system; and
an auxiliary cooling system to recirculate and cool the cabin air when the engine is not operating, the auxiliary cooling system includes a second closed loop, vapor-cycle system that is independent from the first closed loop, vapor-cycle system.

20. The system as defined in claim 19, wherein the auxiliary cooling system is positioned in a pack bay area of a fuselage of the aircraft.
